(19) United States
(12) Patent Application Publication
(10) Pub. No.: US 2001/0051861 A1
(43) Pub. Date: Dec. 13, 2001

(54) Method and apparatus for simulation, and a computer product

(75) Inventors: Naohiro Tamura, Kawasaki (JP); Koji Ishibashi, Kawasaki (JP)

Correspondence Address: Patrick G. Burns, GREER, BURNS & CRAIN, LTD., 300 S. Wacker, 25th Floor, Chicago, IL, 60606, US

(73) Assignee: FUJITSU LIMITED

(21) Appl. No.: 09/751,889

(22) Filed: Dec. 29, 2000

(30) Foreign Application Priority Data
Jun. 9, 2000 (JP) 2000-173383

(51) Int. Cl. G06F 17/50

(52) U.S. Cl. 703/13

(57) ABSTRACT

A simulator includes a model generation/management section that generates and manages a model corresponding to a system to be simulated; a scenario generation/management section that prepares a future-forecasting scenario for verifying a state that the system does not satisfy a predetermined performance standard in future, and at the same time, prepares a design-supporting scenario for verifying a state that the system satisfies the predetermined performance standard; a simulation engine that executes a simulation corresponding to the future-forecasting scenario or the design-supporting scenario; and a simulation control section that controls a simulation corresponding to the design-supporting scenario or the future-forecasting scenario based on a result of a simulation of the future-forecasting scenario or the design-supporting scenario.

### FIELD OF THE INVENTION

The present invention relates to a method and apparatus (simulator) which simulates a number of accesses and a design supporting relating to a computer network. This invention also relates to a computer-readable recording medium which stores a computer program that realizes the method according to the present invention on a computer.

### BACKGROUND OF THE INVENTION

Conventionally, simulations are performed in various fields. Such simulations are generally performed using computers, and are performed in order to solve the problem(s) that may arise in reality. Simulations involve preparation of models that express characteristics of events that occur in reality and their relationships and by changing parameters of the models. In order to execute a simulation to obtain a proper measure for solving problems, high-level knowledge has been required to prepare a scenario about what parameters are to be changed and how to change these parameters.

Therefore, in reality, it is a current situation that the implementation of a simulation has to depend on only a part of specialists in this art. Further, it is also a current situation that despite a fact that a simulation becomes increasingly important in the present society having more complex problems, it has not been able to sufficiently satisfy this need. Under this background, it has been strongly desired to obtain means and methods that can effectively solve these problems.

FIG. 33 is a block diagram showing a structure of a conventional simulator. This simulator executes a discrete type simulation. A computer simulation is broadly divided into two of a continuous type simulation and a discrete type simulation. In the continuous type simulation, changes in a state are taken up as continuously changing quantities, and an event is modeled based on these quantities. On the other hand, in the discrete type simulation, changes in a sate are taken up based on a point of time when an important change has occurred, and an event is modeled based on this change.

FIG. 34 is a diagram for explaining the discrete type simulation. FIG. 34 shows a certain system that has been modeled. The model shown in this drawing expresses an event that queues 4₁ to 4₆ are generated for a plurality of resources (circles in the drawing). This is a multi-stage queue model. In the queues 4₁ to 4₆, entities join the queue at entity arrival rates λ₁ to λ₆. The entity arrival rates λ₁ to λ₆ are numbers of entities per unit time.

Further, in the resources that correspond to the queues 4₁ to 4₆ respectively, the processing of the entities is executed at resource service rates μ₁ to μ₆ respectively. The resource service rates μ₁ to μ₆ are numbers of the processing of entities per unit time. These entity arrival rates λ₁ to λ₆ and the resource service rates μ₁ to μ₆ are the parameters (variable elements) of the discrete type simulation.

According to the discrete type simulation, a scenario is prepared about what parameters are to be changed and how to change these parameters. Then, the simulation is carried out based on this scenario. After the execution of this simulation, a bottleneck (a shortage in resource and the like) is discovered based on a result of the simulation, and a measure for solving this bottleneck is employed.

Referring back to FIG. 33, a simulator section 1 executes a discrete type simulation (hereinafter to be simply referred to as a simulation). A memory unit 2 stores six kinds of models from a model 3₁ to a model 3₆. Each of these models 3₁ to a model 3₆ is a model of, for example, an actual network (including network devices such as a server and routers), and is provided with variable parameters. The simulator section 1 sequentially loads the models 3₁ to 3₆ onto the simulator section 1 from the memory unit 2, and executes a simulation. Thereafter, the simulator section 1 saves a result of the simulation into the memory unit by relating the result of the simulation to a corresponding model. The simulator section 1 repeats this operation.

Such parameters have the following four kinds from (1) to (4).

(1) Topology: A parameter relating to a state of disposition such as a connection of network devices and a sequence of executing jobs, and routes.

(2) Service rate: A parameter relating to a processing speed such as the performance of network devices and the performance of a computer.

(3) Qualitative arrival rate: A parameter that expresses a state of congestion of a system such as a traffic volume of the network and a job input volume, based on qualitative data. The qualitative data includes a number of staff scheduled to be increased in future, and a number of machines scheduled to be increased in future.

(4) Quantitative arrival rate: A parameter that expresses a state of congestion of a system such as a traffic volume of the network and a job input volume, based on quantitative data. The quantitative data includes log (historical data).

FIG. 35 is a diagram for explaining the operation of the above-described conventional simulator. In FIG. 35, portions corresponding to those in FIG. 33 are attached with identical reference numbers. Models 3₁ to 3₃ shown in FIG. 33 are prepared by a user having special knowledge, based on a future-forecasting scenario 5. The future-forecasting scenario 5 in this case is a scenario that defines what parameter is to be changed and to what extent this parameter is to be changed in order to change a model that satisfies a predetermined standard (hereinafter to be referred as a performance standard) as a result of carrying out a simulation into a model that does not satisfy the performance standard.

In other words, the future-forecasting scenario 5 is a scenario that searches conditions (parameters) under which a model that satisfies a performance standard does not satisfy the performance standard in future, and that forecasts what level of performance a system can exhibit at what level of input in future. This future-forecasting scenario 5 is prepared by a user who has special knowledge. For example, according to the future-forecasting scenario 5, of the above-described parameters (1) to (4), the topology and the service rate are constant values and the qualitative arrival rate and the quantitative arrival rate are variables.

As one example of the performance standard, a round trip time is taken up in the case of a model relating to a network. The round trip time (to be referred to as RTT) is a time from when a client has sent a request to a server till when a response to this request from the server has reached the client, within one segment (for example, a segment constituted by the client and the server) of the network.

In the mean time, the models 3₄ to 3₆ are prepared by the user who has special knowledge, based on a design-supporting scenario 6. The design-supporting scenario 6 in this case refers to a scenario that defines what parameter is to be changed and to what extent this parameter is to be changed in order to change a model that does not satisfy a performance standard as a result of carrying out a simulation into a model that satisfies the performance standard.

In other words, the design-supporting scenario 6 is a scenario that searches conditions (parameters) under which a model that does not satisfy a performance standard at the time of designing a network, and that verifies what system structure is optimum in order for the existing system to secure a certain performance standard for a certain input. This design-supporting scenario 6 is prepared by a user who has special knowledge. For example, according to the design-supporting scenario 6, of the above-described parameters (1) to (4), the qualitative arrival rate and the quantitative arrival rate are constant values and the topology and the service rate are variable values.

In the simulator shown in FIG. 33, the models 3₁ to 3₃ that have been prepared based on the future-forecasting scenario 5 and the models 3₄ to 3₆ that have been prepared based on the design-supporting scenario 6 are managed separately. There is no particular relationship established between these two sets of models. In other words, according to the conventional simulator, there is no concept of a metascenario 7 as shown in FIG. 35. The metascenario 7 is for relating the future-forecasting scenario 5 and the design-supporting scenario 6 to each other.

In the above-described structure, for carrying out a future forecast, the simulator section 1 (refer to FIG. 33) loads the model 3₁ shown in FIG. 35 onto the simulator section 1 from the memory unit 2, and executes a simulation based on the model 3₁. In this case, the future forecast means to search conditions under which an existing network that satisfies a performance standard does not satisfy the performance standard in future, by executing a simulation a few times using a plurality of models that are set with variable parameters. The simulator section 1 displays a result of the simulation into a display section (not shown), and at the same time, saves the simulation result into the memory unit 2 by relating the simulation result to the model 3₁. In this case, it is assumed that the simulation result relating to the model 3₁ is a result that satisfies the performance standard.

Next, the simulator section 1 loads the model 3₂ onto the simulator section 1 from the memory unit 2, and executes a simulation based on the model 3₂. The simulator section 1 displays a result of the simulation into the display section (not shown), and at the same time, saves the simulation result into the memory unit 2 by relating the simulation result to the model 3₂. In this case, it is assumed that the simulation result relating to the model 3₂ is a result that also satisfies the performance standard. Next, the simulator section 1 loads the model 3₃ onto the simulator section 1 from the memory unit 2, and executes a simulation based on the model 3₃.

The simulator section 1 displays a result of the simulation into the display section (not shown), and at the same time, saves the simulation result into the memory unit 2 by relating the simulation result to the model 3₃. In this case, it is assumed that the simulation result relating to the model 3₃ is a result that does not satisfy the performance standard. Thus, a user obtains information about conditions under which the existing network does not satisfy the performance standard, based on the results of the simulations, and makes use of the information for operating the network in future.

For improving existing or potential performance problems of an existing network, the user receives a design support for redesigning the network, from the simulation results. In this case, the simulator section 1 loads the model 3₄ shown in FIG. 35 onto the simulator section 1 from the memory unit 2, and executes a simulation based on the model 3₄. The simulator section 1 displays a result of the simulation into the display section (not shown), and at the same time, saves the simulation result into the memory unit 2 by relating the simulation result to the model 3₄. In this case, it is assumed that the simulation result relating to the model 3₄ is a result that does not satisfy the performance standard.

Next, the simulator section 1 loads the model 3₅ onto the simulator section 1 from the memory unit 2, and executes a simulation based on the model 3₅. The simulator section 1 displays a result of the simulation into the display section (not shown), and at the same time, saves the simulation result into the memory unit 2 by relating the simulation result to the model 3₅. In this case, it is assumed that the simulation result relating to the model 3₄ is a result that does not satisfy the performance standard either. Next, the simulator section 1 loads the model 3₆ onto the simulator section 1 from the memory unit 2, and executes a simulation based on the model 3₆.

The simulator section 1 displays a result of the simulation into the display section (not shown), and at the same time, saves the simulation result into the memory unit 2 by relating the simulation result to the model 3₆. In this case, it is assumed that the simulation result relating to the model 3₄ is a result that satisfies the performance standard. Thus, the user obtains information about conditions under which the existing network satisfies the performance standard, based on the results of the simulations, and makes use of the information for operating the network in future.

As described above, according to the conventional simulator, it is possible to generate a model by defining parameters in detail based on the scenarios (the future-forecasting scenario 5 and the design-supporting scenario 6). Therefore, the conventional simulator is a device that can be easily handled by a specialist user who has ample knowledge about simulation and model architecture.

On the other hand, a general user who does not have the above knowledge is forced to carry out the preparation of a scenario by directly changing parameters. Therefore, it is hard for this user to use the simulator. In order for a general user to be able to skillfully use the simulator, the user must learn and master at least the following.

(a) The user needs to learn and master the theory of a discrete type simulation and the theory of queue, and then to acquire a relationship between a model and parameters.

(b) The user needs to learn and master what kind of scenario can be obtained when parameters are changed.

(c) The user needs to learn and master that there are parameters that must be changed and parameters that must not be changed among a plurality of kinds of parameters in order to achieve a certain scenario.

However, in actual practice, it is very difficult for a general user to learn and master the above skills during a short period of time. Therefore, only a part of users skilled in the art has been able to handle the conventional simulator, and it has been very difficult for general users to start the conventional simulator.

Further, as shown in FIG. 35, in the conventional simulator, there has been no particular relationship established between the future-forecasting scenario 5 and the design-supporting scenario 6. Therefore, the models 3₁ to 3₃ prepared based on the future-forecasting scenario 5 and the models 3₄ to 3₆ prepared based on the design-supporting scenario 6 have been managed separately.

Further, in the conventional simulator, there has been a close relationship between the future-forecasting scenario 5 and the design-supporting scenario 6 with the performance standard as a boundary. There exists no metascenario 7 that combines the future-forecasting scenario 5 and the design-supporting scenario 6 together to have a mutual relationship. Therefore, according to the conventional practice, a user must prepare a scenario corresponding to this metascenario 7 and manage it by himself or herself. Thus, this has been a very heavy burden for the user.

### SUMMARY OF THE INVENTION

It is an object of the present invention to provide a simulator and a simulation method capable of enabling a general user to effectively carry out a simulation without forcing the user to acquire high-level knowledge of simulation and without applying a burden onto the user, and to provide a computer-readable recording medium recorded with a simulation program.

According to the present invention, a future-forecasting scenario and the design-supporting scenario are prepared, and a simulation corresponding to the design-supporting scenario or the future-forecasting scenario is executed based on a result of executing a simulation of the future-forecasting scenario or the design-supporting scenario. Therefore, even a general user can carry out an effective simulation without forcing the user to acquire high-level knowledge about simulation and without applying a burden onto the user.

Other objects and features of this invention will become apparent from the following description with reference to the accompanying drawings.

### BRIEF DESCRIPTION OF THE DRAWINGS

FIG. 1 is a diagram for explaining an outline of one embodiment relating to the present invention.

FIG. 2 is a diagram for explaining an outline operation of the same embodiment.

FIG. 3 is a block diagram showing a structure of the same embodiment.

FIG. 4 is a diagram showing a structure of a computer network 100 shown in FIG. 3.

FIG. 5 is a diagram showing a structure of simulation data 540 shown in FIG. 3.

FIG. 6 is a diagram showing various parameters used in the same embodiment.

FIG. 7 is a diagram showing one example of topology data 410 shown in FIG. 3.

FIG. 8 is a diagram showing one example of managed-device performance data 420 shown in FIG. 3.

FIG. 9 is a diagram showing one example of traffic history data 430 and future projected value data 440 shown in FIG. 3.

FIG. 10 is a diagram showing one example of transaction history data 450 and transaction projected value data 460 shown in FIG. 3.

FIG. 11 is a flowchart for explaining an operation of the same embodiment.

FIG. 12 is a flowchart for explaining a model setting processing shown in FIG. 11.

FIG. 13 is a diagram showing a screen 700 in the model setting processing shown in FIG. 12.

FIG. 14 is a diagram showing a screen 710 in the model setting processing shown in FIG. 12.

FIG. 15 is a diagram showing a screen 720 in the model setting processing shown in FIG. 12.

FIG. 16 is a diagram showing a screen 730 in the model setting processing shown in FIG. 12.

FIG. 17 is a diagram showing a screen 740 in a topology display processing shown in FIG. 12.

FIG. 18 is a flowchart for explaining a scenario preparation processing shown in FIG. 11.

FIG. 19 is a flowchart for explaining a future-forecasting scenario preparation processing shown in FIG. 18.

FIG. 20 is a diagram showing a screen 750 in the future-forecasting scenario preparation processing shown in FIG. 18.

FIG. 21 is a diagram showing a screen 760 in the future-forecasting scenario preparation processing shown in FIG. 18.

FIG. 22 is a diagram for explaining the future-forecasting scenario preparation processing shown in FIG. 19.

FIG. 23 is a flowchart for explaining a design-supporting scenario preparation processing shown in FIG. 18.

FIG. 24 is a diagram for explaining the design-supporting scenario preparation processing shown in FIG. 23.

FIG. 25 is a flowchart for explaining a simulation execution processing shown in FIG. 11.

FIG. 26 is a flowchart for explaining a result display processing shown in FIG. 11.

FIG. 27 is a diagram showing a screen 770 in the result display processing shown in FIG. 26.

FIG. 28 is a diagram showing a screen 780 in the result display processing shown in FIG. 26.

FIG. 29 is a diagram showing a screen 790 in the result display processing shown in FIG. 26.

FIG. 30 is a diagram showing a screen 800 in the result display processing shown in FIG. 26.

FIG. 31 is a diagram showing a screen 810 in the result display processing shown in FIG. 26.

FIG. 32 is a block diagram showing a modification of the same embodiment.

FIG. 33 is a block diagram showing a structure of a conventional simulator.

FIG. 34 is a diagram for explaining a discrete type simulation.

FIG. 35 is a diagram for explaining an operation of the conventional simulator.

### DESCRIPTION OF THE PREFERRED EMBODIMENTS

One preferred embodiment of a simulator, a simulation method and a computer-readable recording medium recorded with a simulation method relating to the present invention will be explained in detail with reference to the drawings.

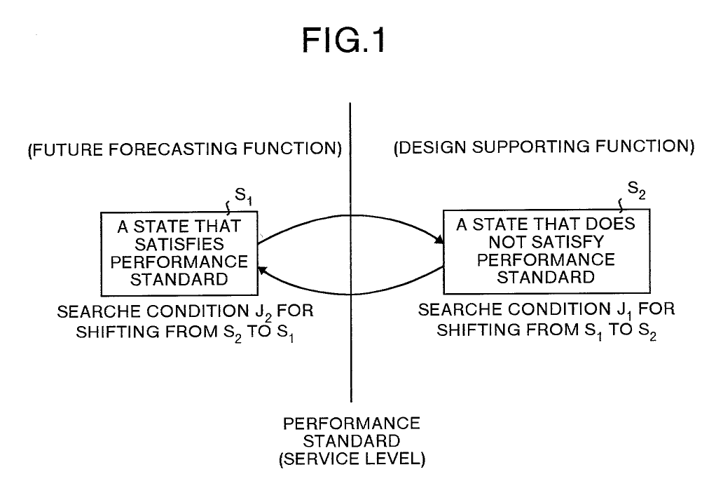

FIG. 1 is a diagram for explaining an outline of one embodiment relating to the present invention. FIG. 1 shows a mutual relationship between a future forecasting function and a design supporting function that are basic functions of a simulator. The future forecasting function refers to a function that searches a condition J₁ for shifting a state S₁ in which a performance standard (a service level) is satisfied into a state S₂ in which the performance standard is not satisfied, by executing a simulation based on the future-forecasting scenario. On the other hand, the design supporting function refers to a function that searches a condition J₂ for shifting the state S₂ in which the performance standard is not satisfied into the state S₁ in which the performance standard is satisfied, by executing a simulation based on the design-supporting scenario.

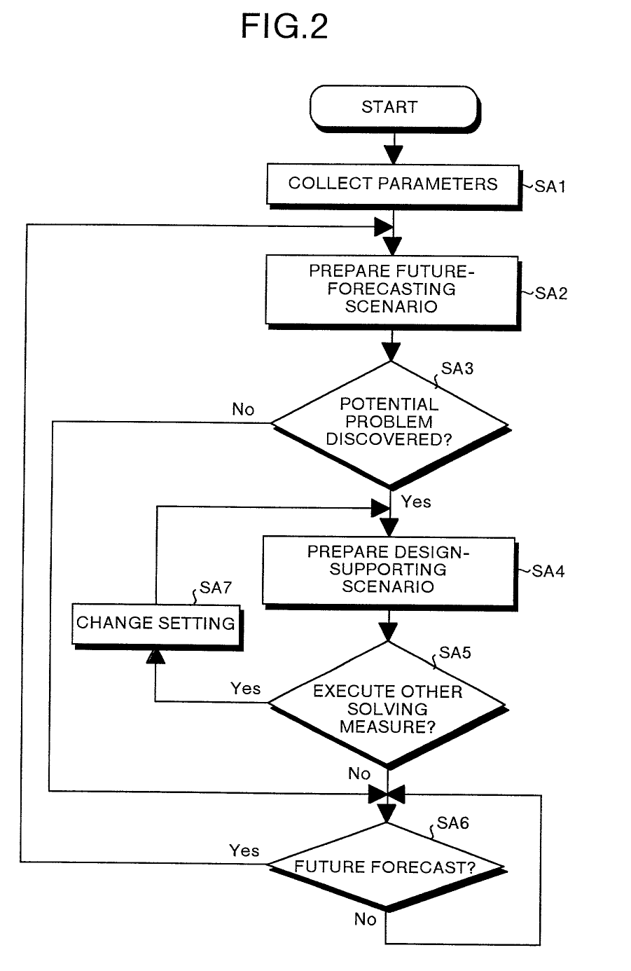

FIG. 2 is a diagram for explaining an outline operation of this embodiment. At step SA1 shown in FIG. 2, parameters that are necessary for carrying out a simulation are collected. At step SA2, a future-forecasting scenario is prepared, and after that, a simulation is carried out based on this future-forecasting scenario. At step SA3, a decision is made as to whether a potential problem has been discovered or not based on a result of the simulation. In other words, a decision is made as to whether a simulation result satisfies the performance standard shown in FIG. 1 or not.

When a result of the decision made at step SA3 is “No”, a decision is made at step SA6 as to whether a future forecasting based on the future-forecasting scenario is to be executed next or not. When a decision made at step SA6 is “No”, the same decision-making is repeated. When a decision made at step SA6 is “Yes”, the processing at step SA2 afterward is repeatedly carried out.

On the other hand, when a result of the decision made at step SA3 is “Yes”, that is, when a simulation result does not satisfy the performance standard shown in FIG. 1, a design-supporting scenario is prepared. After that, a simulation is carried out based on this design-supporting scenario at step SA4. At step SA5, as the simulation result does not satisfy the performance standard, a decision is made as to whether other solving measure is to be executed or not.

When a result of the decision made at step SA5 is “Yes”, the setting of the parameters are updated at step SA7. At step SA4, a design-supporting scenario is prepared based on the parameters after the updating, and after that, a simulation is executed based on this design-supporting scenario. When a result of the simulation carried out at step SA4 satisfies the performance standard (refer to FIG. 1), a result of the decision made at step SA5 becomes “No”, and the above-described decision-making at step SA6 is carried out.

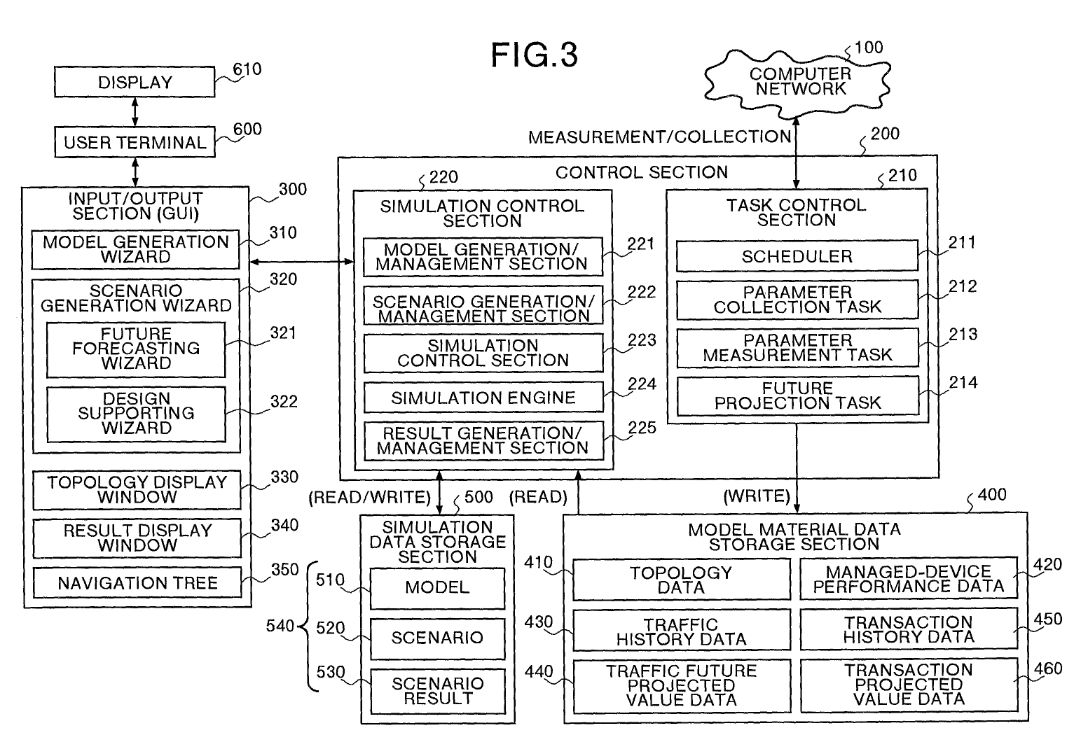

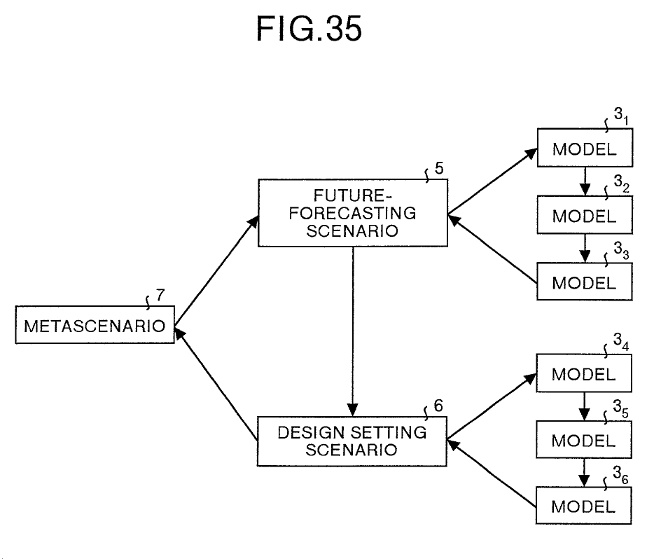

As explained above, the present embodiment is characterized in that the simulator has a function of relating the future-forecasting scenario and the design-supporting scenario to each other like the metascenario 7 (refer to FIG. 35). The present embodiment will be explained in further detail with reference to FIG. 3 to FIG. 31.

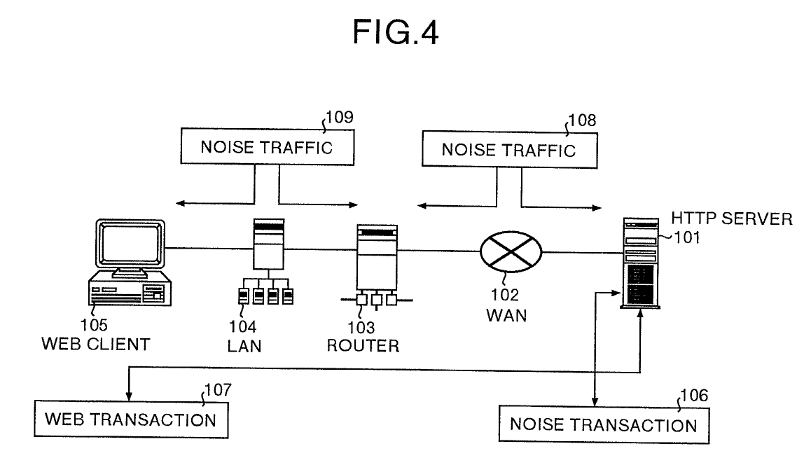

FIG. 3 is a block diagram showing a structure of the embodiment relating to the present invention. In FIG. 3, a computer network 100 is for the future forecasting and the design supporting, and this has a structure as shown in FIG. 4. In FIG. 4, an HTTP (HyperText Transfer Protocol) server 101 is a server that transfers an HTML (HyperText Markup Language) file and an image file to a Web client 105 at a transfer request from the Web client 105 according to the HTTP. The HTTP server 101 is connected to a WAN (Wide Area Network) 102.

The WAN 102 is connected to a LAN (Local Area Network) 104 via a router 103. The Web client 105 is connected to the LAN 104, and issues a transfer request to the HTTP server 101 via the LAN 104, the router 103 and the WAN 102. The Web client 105 then receives the HTML file and the image file from the HTTP server 101. The time from when the Web client 105 has issued the transfer request till when the Web client 105 has received the HTML file or the image file (a time from the start to the end of one transaction) is the above-described round-trip time (the same as a response time). This round-trip time is a parameter that is used for making a decision as to whether the performance standard (service level) of the computer network 100 is satisfied or not.

A noise transaction 106 is a transaction that is processed between a large number of unspecified Web clients (not shown) and the HTTP server 101. A Web transaction 107 is a transaction that is processed between the Web client 105 and the HTTP server 101. A noise traffic 108 is a traffic that is processed between the HTTP server 101 and the router 103. A noise traffic 109 is a traffic that flows between the Web client 105 and the router 103.

A control section 200 shown in FIG. 3 consists of a task control section 210 that controls the execution of various tasks relating to a simulation, and a simulation control section 220 that controls the execution of the simulation. In the task control section 210, a scheduler 211 executes a parameter collection task 212, a parameter measurement task 213, and a future projection task 214, according to a task execution schedule that has been set in advance by a user.

The parameter collection task 212 is a task for collecting parameters from the computer network 100. The parameter measurement task 213 is a task for measuring parameters in the computer network 100. The future projection task 214 is a task for executing a future projection to be described later. In the simulation control section 220, a model generation/management section 221 generates and manages a model in a simulation.

A scenario generation/management section 222 prepares and manages a scenario in a simulation. A simulation control section 223 controls the execution of a simulation. A simulation engine 224 executes a simulation under the control of the simulation control section 223. A result generation/management section 225 generates and manages a result of a simulation in the simulation engine 224.

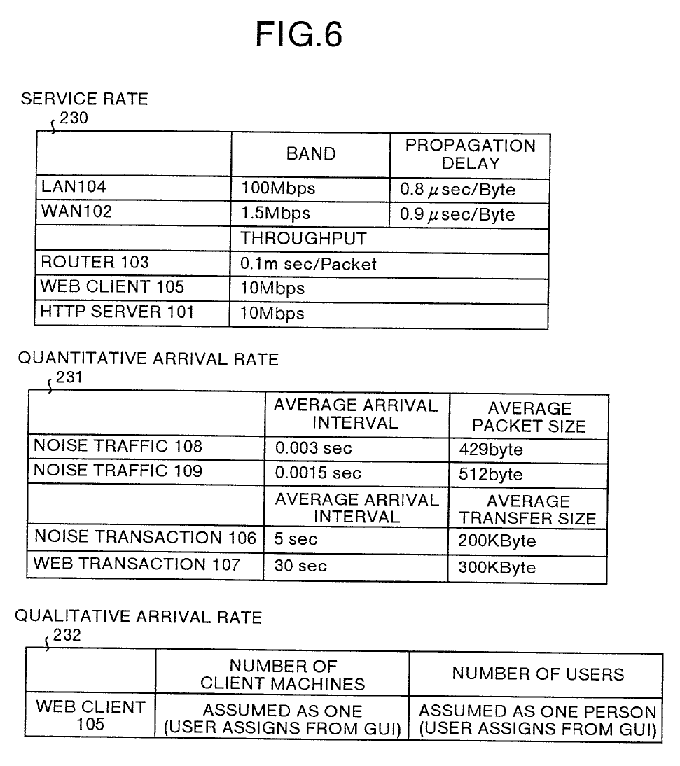

FIG. 6 is a diagram showing various parameters used in the present embodiment. FIG. 6 shows three parameters (a service rate 230, a quantitative arrival rate 231, and a qualitative arrival rate 232) of the computer network 100 shown in FIG. 4 out of the four parameters (the topology, the service rate, the quantitative arrival rate, and the qualitative arrival rate) described previously.

In the service rate 230, the service rates of the LAN 104 (refer to FIG. 4) are 100 Mbps for the “band” and 0.8 μsec/byte for the “propagation delay”. The service rates of the WAN 102 are 1.5 Mbps for the “band”, and 0.9 μsec/byte for the “propagation delay”. The service rate of the router 103 is 0.1 msec/packet for the “throughput”. The service rate of the Web client 105 is 10 Mbps for the “throughput”. The service rate of the HTTP server 101 is 10 Mbps for the “throughput”.

In the quantitative arrival rate 231, the quantitative arrival rate of the noise traffic 108 is 0.003 sec for the “average arrival interval”. The “average packet size” in this case is 429 bytes. The quantitative arrival rate of the noise traffic 109 is 0.0015 sec for the “average arrival interval”. The “average packet size” in this case is 512 bytes.

The quantitative arrival rate of the noise transaction 106 is 5 sec for the “average arrival interval”. The “average transfer size” in this case is 200 Kbytes. The quantitative arrival rate of the Web transaction 107 is 30 sec for the “average arrival interval”. The “average transfer size” in this case is 300 Kbytes. In the qualitative arrival rate 232, the qualitative arrival rate of he Web client 105 is assumed as one machine for the “number of client machines” and is assumed as one person for the “number of users”.

Referring back to FIG. 3, various data (model material data) that are necessary for carrying out a simulation are written into a model material data storage section 400, based on a write control of the control section 200. Various data are read from the model material data storage section 400, based on a read control of the control section 200. Specifically, the model material data storage section 400 stores a topology data 410, a managed-device performance data 420, a traffic history data 430, a traffic future projected value data 440, a transaction history data 450, and a transaction projected value data 460.

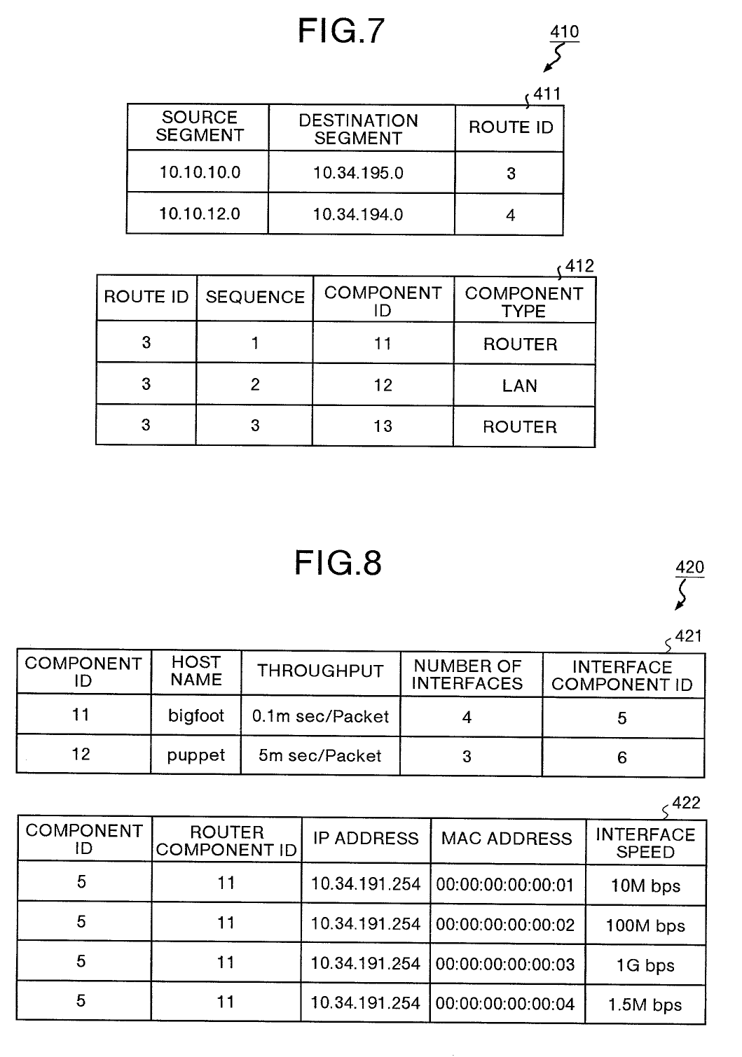

The topology data 410 consists of a topology data 411 and a topology data 412, as shown in FIG. 7. This is a data that expresses the topology (a state of connection between network devices) of the computer network 100. The topology data 411 consists of the data of the “source segment”, the “destination segment”, and the “route ID” respectively. The topology data 412 consists of the data of the “route ID”, the “order”, the “component ID”, and the “component type” respectively. For example, the “component ID”=11 is an identification number for identifying the router 103 shown in FIG. 4.

The managed-device performance data 420 consists of a router performance data 421 and an interface performance data 422, as shown in FIG. 8. The router performance data 421 is a data that expresses the performance of the router 103 (refer to FIG. 4), and consists of the data of the “component ID”, the “host name”, the “throughput”, the “number of interfaces”, and the “interface component ID” respectively.

On the other hand, the interface performance data 422 is a data that expresses the performance of an interface in the computer network 100. The interface performance data 422 consists of the data of the “component ID”, the “router component ID”, the “IP address”, the “MAC address”, and the “interface speed” respectively.

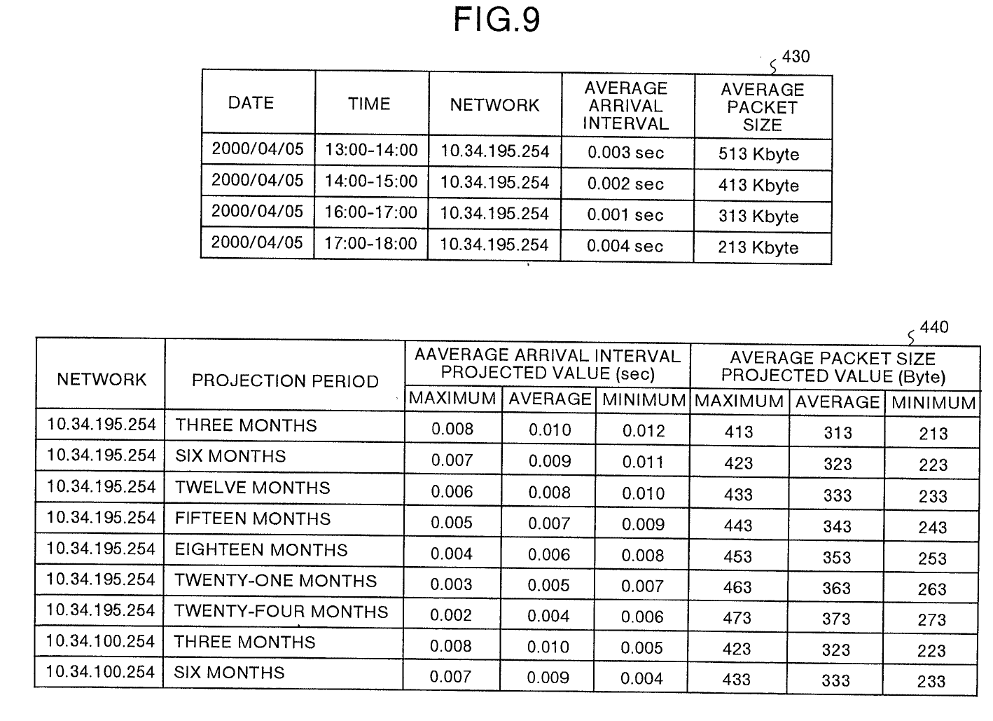

The traffic history data 430 is a history data of the traffic (a noise traffic 108 and a noise traffic 109) in the computer network 100 (refer to FIG. 4), as shown in FIG. 9. Specifically, the traffic history data 430 consists of the data of the “date” that shows a date when a corresponding traffic has occurred, the “time” that shows a time zone when the traffic has occurred, the “network” that shows a network address, the “average arrival interval”, and the “average packet size” respectively.

The traffic future projected value data 440 consists of the “network” for specifying a network to be projected in future, the “projection period” to be projected in future, the “average arrival interval projected value”, and the “average packet size projected value”. The future projection in this case refers to a forecasting of a traffic volume (the “average arrival interval projected value” and the “average packet size projected value”) at a point of time after a projection period from now, by projecting known parameters (the “average arrival interval” and the “average packet size” in the traffic history data 430) based on a simple regression analysis method. The “average arrival interval projected value” is obtained for a maximum value, an average value and a minimum value respectively within a reliability range of 95%. Similarly, the “average packet size projected value” is also obtained for a maximum value, an average value and a minimum value respectively within a reliability range of 95%.

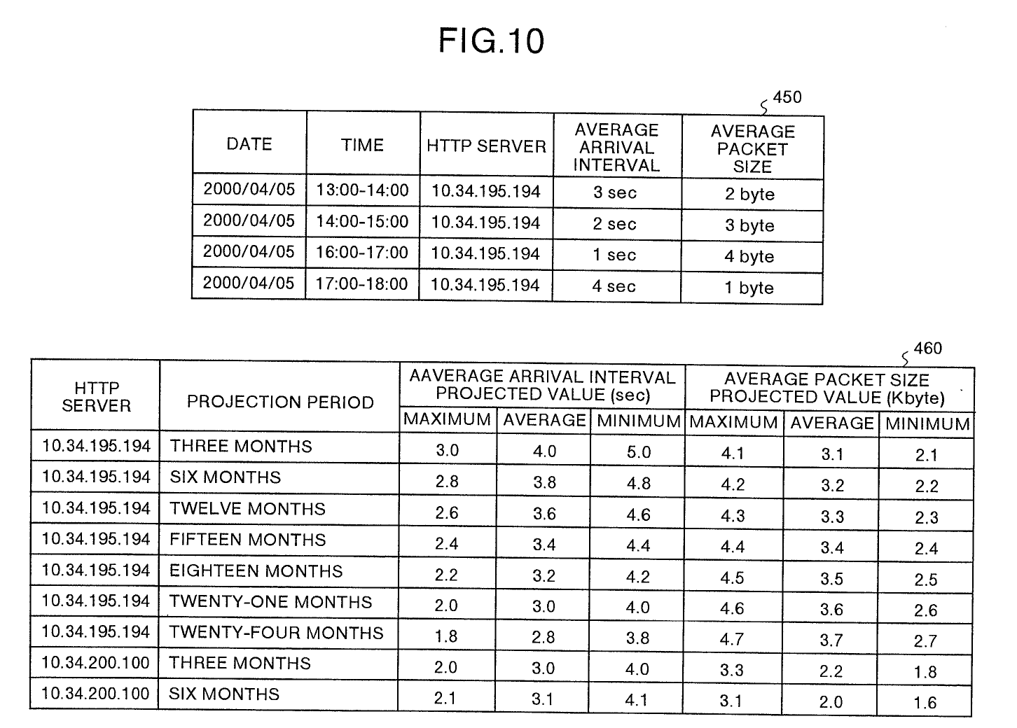

The transaction history data 450 is a history data of the transaction (the noise transaction 106 and the Web transaction 107) in the computer network 100 (refer to FIG. 4) as shown in FIG. 10. In other words, the transaction history data 450 is a data that expresses the history of the number of accesses of the HTTP server 101.

Specifically, the transaction history data 450 consists of the data of the “date” that shows a date when a corresponding transaction has occurred, the “time” that shows a time zone when the transaction has occurred, the “HTT server” that shows a network address of the HTTP server 101 where the transaction has occurred, the “average arrival interval”, and the “average transfer size” respectively.

The transaction projected value data 460 consists of the “HTTP server” that shows a network address of the HTTP server 101, the “projected period” that shows a period to be projected in future, the “average arrival interval projected value”, and the “average transfer size projected value”. The future projection in this case refers to a forecasting of a transaction (a number of accesses) (the “average arrival interval projected value” and the “average transfer size projected value”) at a point of time after a projection period from now, by projecting known parameters (the “average arrival interval” and the “average transfer size” in the transaction history data 450) based on a simple regression analysis method. The “average arrival interval projected value” is obtained for a maximum value, an average value and a minimum value respectively within a reliability range of 95%. Similarly, the “average transfer size projected value” is also obtained for a maximum value, an average value and a minimum value respectively within a reliability range of 95%.

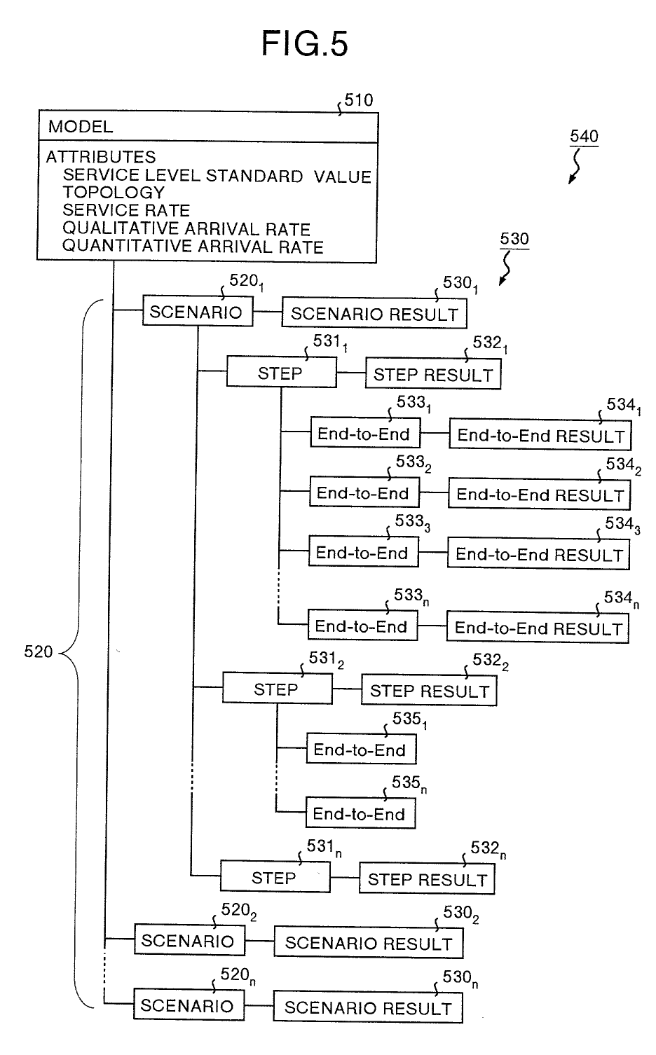

Referring back to FIG. 3, a simulation data storage section 500 stores a simulation data 540 shown in FIG. 5. The simulation data 540 consists of the data of a model 510, a scenario 520, and a scenario result 530. The model 510 shown in FIG. 5 is the computer network 10 that is expressed in a state of a model for a simulation. The attributes of this model are expressed by a service level standard value (corresponding to the performance standard value), a topology, a service rate, a qualitative arrival rate, and a quantitative arrival rate. The scenario 520 consists of n scenarios 520₁ to 520ₙ. The scenario result 530 consists of n scenario results 530₁ to 530ₙ corresponding to the n scenarios 520₁ to 520ₙ.

The scenario 520₁ consists of n steps 531₁ to 531ₙ. The step 531₁ consists of n End-to-End's 533₁ to 533ₙ. The End-to-End correspond to between a terminal and a terminal in the model 510. Results of simulations of these End-to-End's 533₁ to 533ₙ are End-to-End results 534₁ to 534ₙ respectively. These End-to-End results 534₁ to 534ₙ are a result of a step result 532₁.

In a similar manner to that of the step 531₁, the step 531₂ consists of n End-to-End's 535₁ to 535ₙ. Results (not shown) of simulations of these End-to-End's 535₁ to 535ₙ are a result of a step result 532₂. Similarly, each of scenarios 520₂ to 520ₙ has a structure similar to that of the scenario 520₁. Also, each of scenario results 530₂ to 530ₙ has a structure similar to that of the step result 532₁.

Referring back to FIG. 3, an input/output section 300 exists between a user terminal 600 and the control section 200. The input/output section 300 has a function of displaying by a GUI (Graphical User Interface) various icons and windows that are necessary for carrying out a simulation in a display 610 connected to the user terminal 600.

In the input/output section 300, a model generation wizard 310 has a function of making the display 610 display a sequence of generating a model. A scenario generation wizard 320 consists of a future forecasting wizard 321 and a design supporting wizard 322, and has a function of making the display 610 display a sequence of carrying out the future forecasting and the design supporting.

A topology display window 330 is a window for making the display 610 display a topology of a simulation. A result display window 340 is a window for making the display 610 display a simulation result. A navigation tree 350 is for navigating an operation procedure of the simulator. The user terminal 600 is a computer terminal for issuing various instructions to the simulator and for making the display 610 display various information.

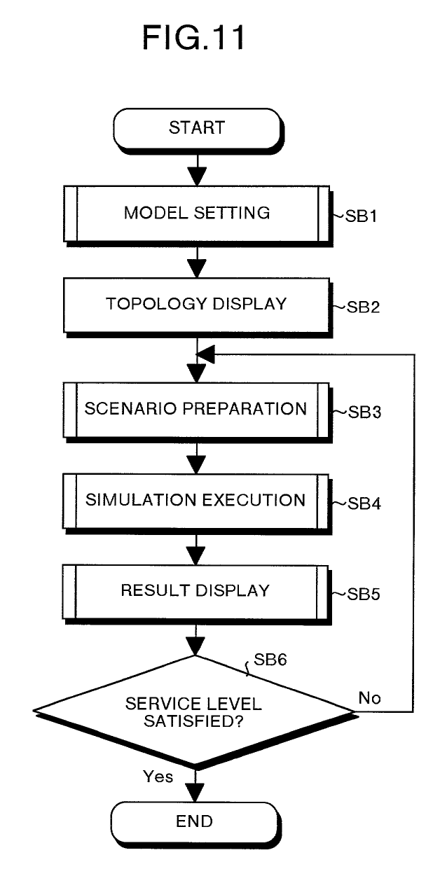

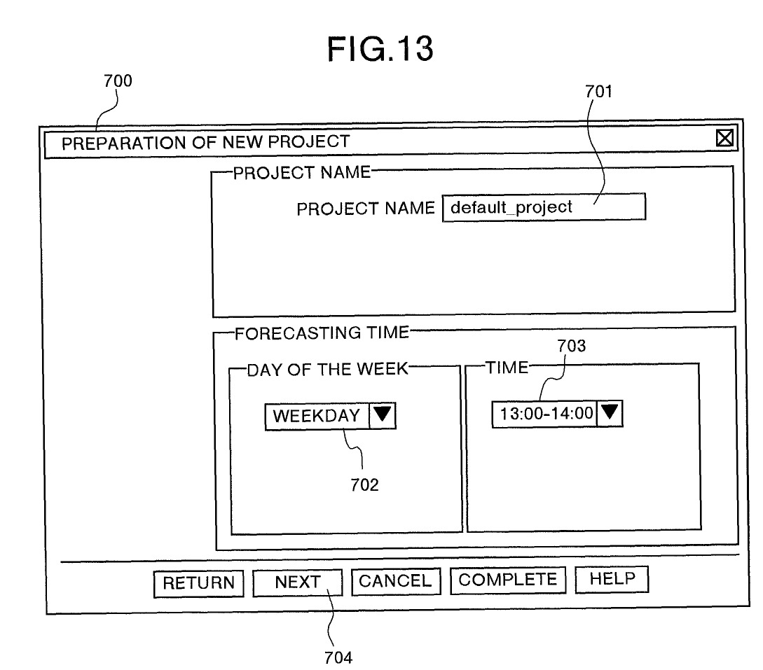

The operation of the present embodiment will be explained with reference to FIG. 11 to FIG. 31. FIG. 11 is a flowchart for explaining the operation of the present embodiment. At step SB1 in FIG. 11, a model setting processing for setting a model that is used in the simulation is executed. In other words, when a model setting instruction has been issued from the user terminal 600 shown in FIG. 3, the model generation wizard 310 is started, and a screen 700 shown in FIG. 13 is displayed in the display 610.

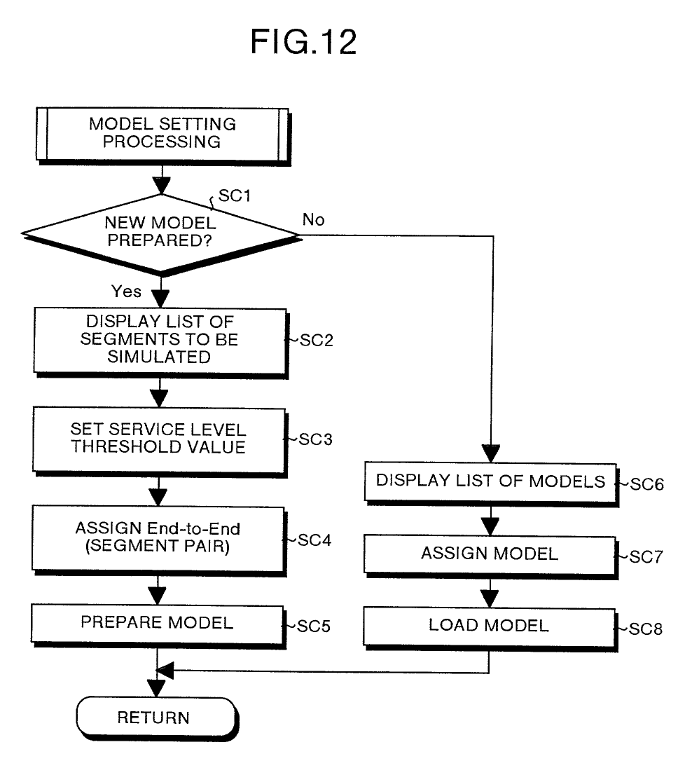

At step SC2 shown in FIG. 12, the model generation/management section 221 makes a decision as to whether a new model generation instruction has been issued from the user terminal 600 or not. Referring to FIG. 13, a user inputs “default#project” (hereinafter, an under-bar shown in the drawing is expressed by # in the present specification) as a project name into a project name input column 701, inputs “weekday” as a day of the week of a (future) forecasting period into a weekday input column 702, and inputs “13:00-14:00” as a time into a time input column 703. Then, the user depresses a next-screen shift button 704. Thereafter, the model generation/management section 221 sets “Yes” as a result of a decision made at step SC1.

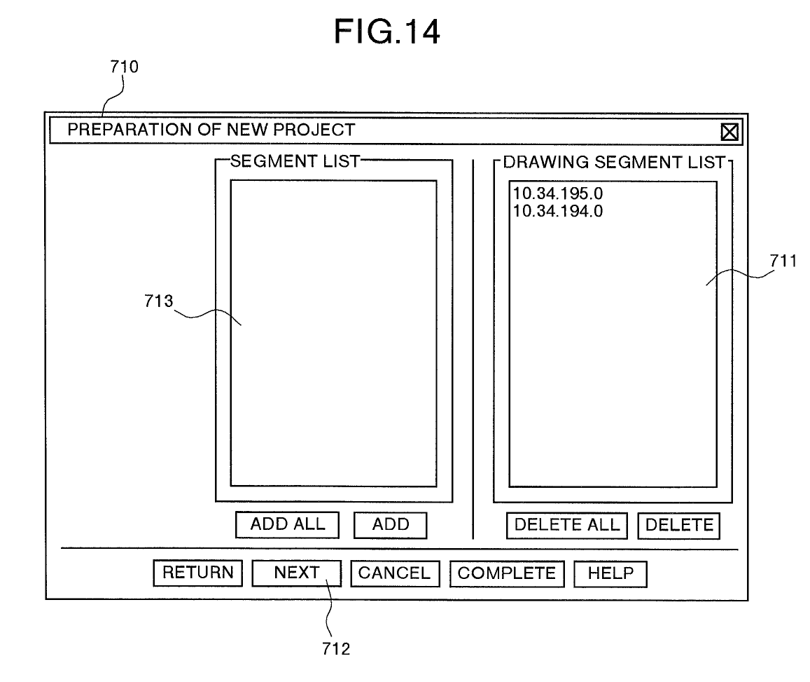

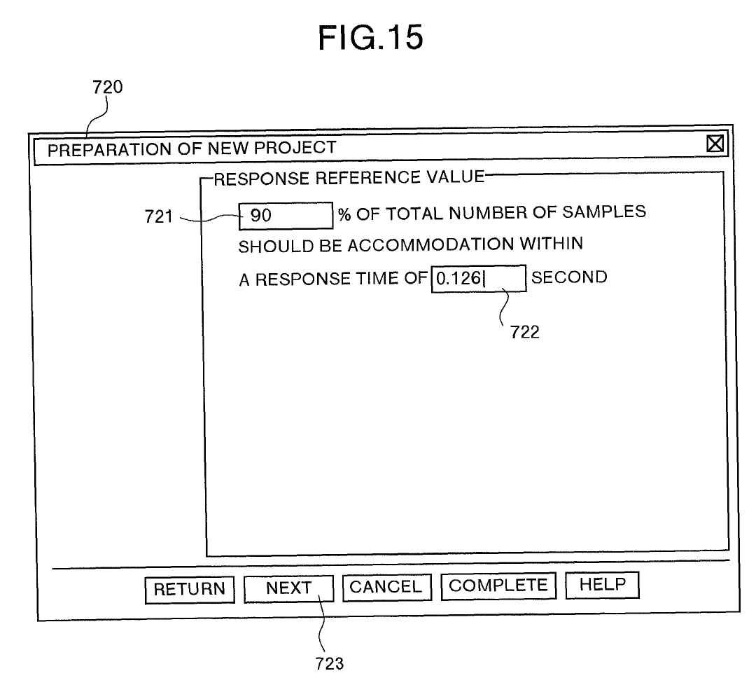

Thus, at step SC2, the model generation/management section 221 displays a screen 710 shown in FIG. 14, and at the same time, makes the user select from the user terminal 600 a simulation segment list (a drawing segment list 711) from a management segment list (a segment list 713). The simulation segment list refers to a segment for a simulation among segments to be managed in the computer network 100 (refer to FIG. 4). When a next-screen shift button 712 has been depressed, the display 610 displays a screen 720 shown in FIG. 15. This screen 720 is a screen for setting a threshold value of a service level (performance standard).

At step SC3, the user inputs “90” % into a percent data input column 721, and “0.126” second into a reference response time input column 722, from the user terminal 600. In other words, in this case, the service level is based on that 90% of a total number of samples falls within the response time 0.126 second in the transaction of a segment pair assigned at step SC4 to be described later. The total number of samples in this case refers to a total number of samples (response time (=a round-trip time)).

For example, in the segment pair, when a ten-second simulation is executed in the case where a transaction occurs at the arrival rate of one time per one second, it is possible to obtain ten samples on average (=response time). The total number of samples is “10” in this case. Therefore, based on the standard of the service level input at step SC3, the service level is met when at least “nine” samples (90%) of the “10” samples are within 0.126 second. At step SC4, the user assigns a segment pair (End-to-End) for the simulation from the user terminal 600. The segment pair (End-to-End) is a set of one terminal (End) and the other terminal (End) that constitute a segment.

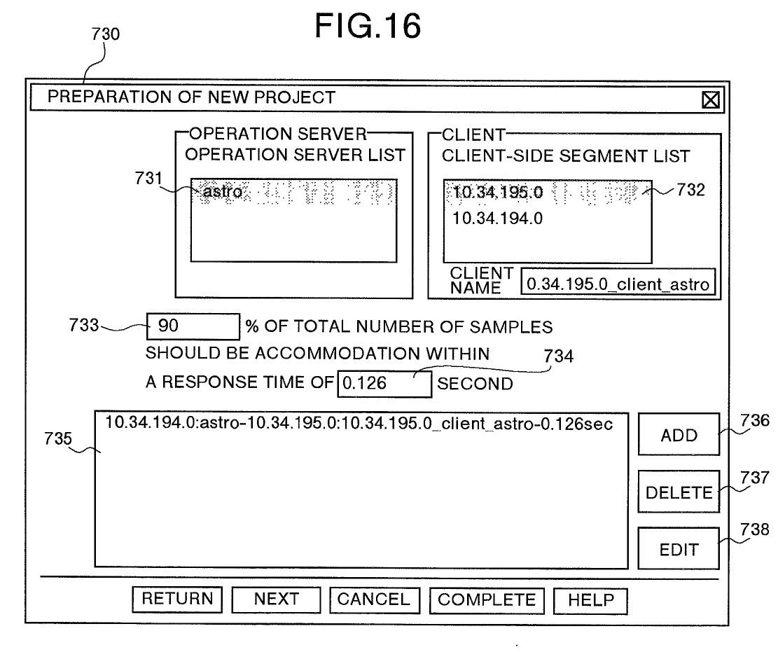

In other words, when a next-screen shift button 723 has been depressed, the display 610 displays a screen shown in FIG. 16. Thus, the user assigns a segment pair. In this case, the user assigns “astro” (corresponding to the HTTP server 101: refer to FIG. 4) that expresses one terminal of the segment pair from an operation server list 731, and assigns “10.34.195.0” (corresponding to the LAN 104: refer to FIG. 4) that expresses the other terminal of the segment pair from a client-side segment list 732. In this case, in a lower area of the client-side segment list 732, “0.34.195.0#client#astro” (corresponding to the Web client 105: refer to FIG. 4) is displayed as a client name. Further, a percent data display column 733 displays as a default value the “90%” (refer to FIG. 15) that has been input by the user in the screen 720 shown in FIG. 15. A reference response time display column 734 displays as a default value the “0.126” second (refer to FIG. 15) that has been input by the user in the screen 720 shown in FIG. 15. For changing these default values, the user inputs values after the changes, thereby to overwrite the default values. A display column 735 displays the information of a segment pair and the information of a service level threshold value. A screen 730 displays an addition button 736, a deletion button 737, and an editing button 738.

At step SC5 shown in FIG. 12, the model generation/management section 221 prepares a model based on the segment pair and the service level threshold value. On the other hand, when a result of the decision made at step SC1 is “No”, the display 610 displays at step SC6 a list of models that have been already prepared (refer to FIG. 5). At step SC7, a desired model is assigned from out of the list of the models. At step SC8, the model generation/management section 221 loads onto the model generation/management section 221 the model assigned at step SC7 from the simulation data storage section 500.

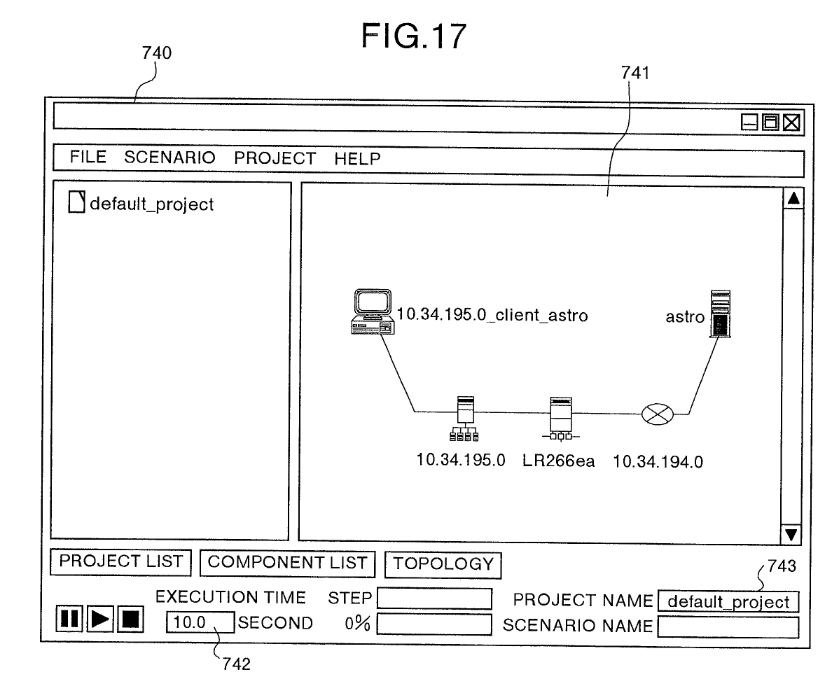

Next, at step SB2 shown in FIG. 11, the topology display window 330 is started, and the display 610 displays a screen 740 shown in FIG. 17. A topology display column 741 of this screen 740 displays the topology corresponding to the computer network 100 shown in FIG. 4. An execution time display column 742 displays the execution time of a simulation, and a project name display section 743 displays a project name.

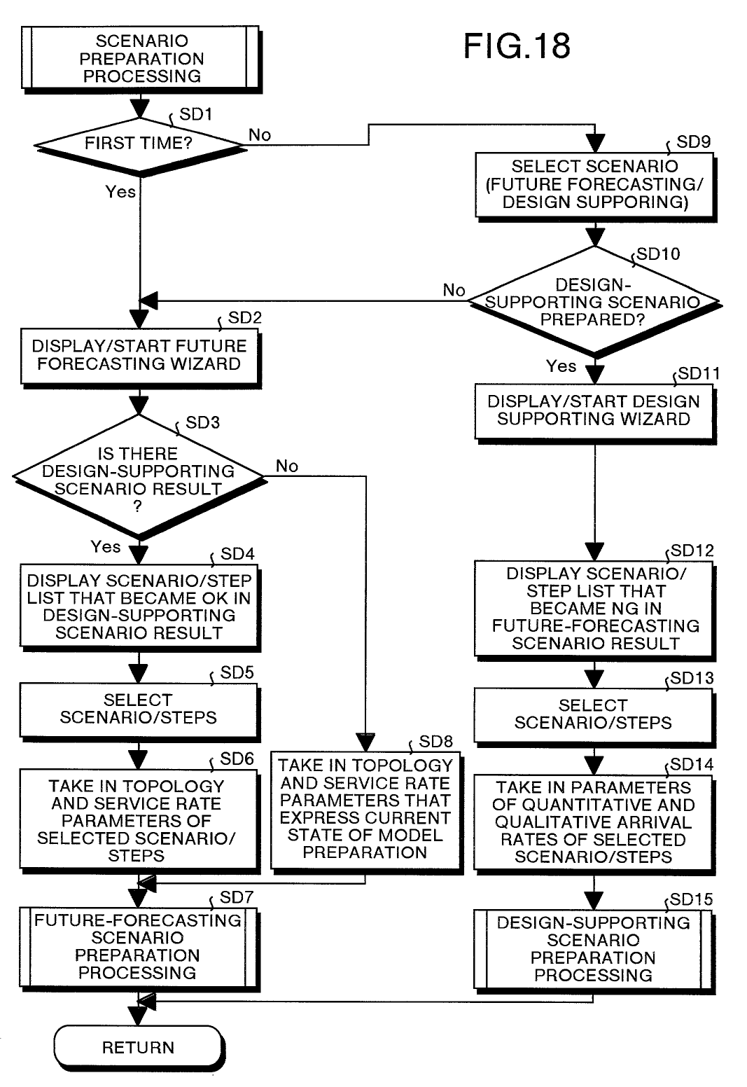

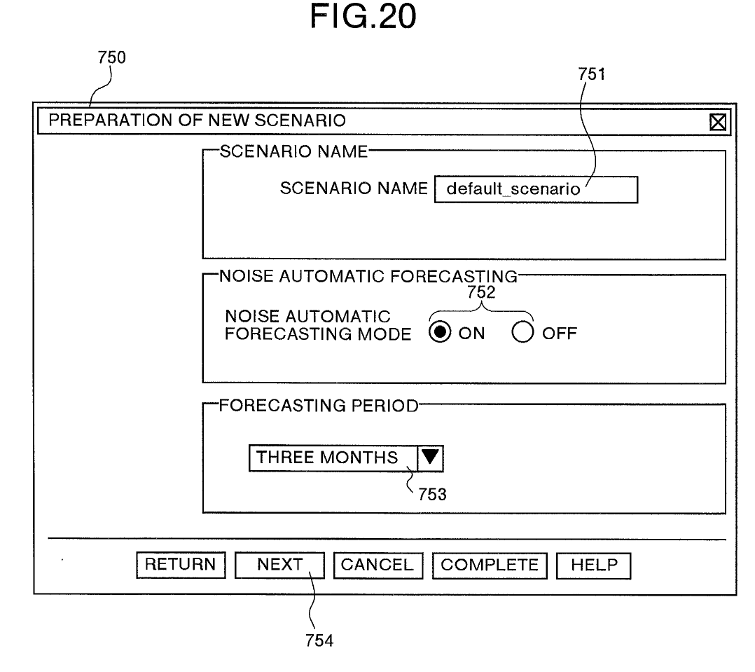

Next, at step SB3 shown in FIG. 11, the scenario generation/management section 222 executes a scenario preparation processing for preparing a scenario. The scenario in this case refers to the future-forecasting scenario and the design-supporting scenario described above. At step SD1 shown in FIG. 18, the scenario generation/management section 222 makes a decision as to whether a scenario is prepared for the first time or not. In this case, a result of the decision made at step SD1 is set to “Yes”. At step SD2, the scenario generation/management section 222 starts the future forecasting wizard 321. Thus, the display 610 displays a screen 750 shown in FIG. 20.

At step SD3, the scenario generation/management section 222 makes a decision as to whether a result based on the design-supporting scenario (the scenario result 530 (refer to FIG. 3)) has been stored in the simulation data storage section 500 or not. In this case, a result of the decision made at step SD3 is set to “No”. At step SD8, the scenario generation/management section 222 takes in the topology that expresses a current state of the model preparation and various parameters of the service rates from the model material data storage section 400. In the future-forecasting scenario, the topology and the parameters of the service rates are used as constant values.

When a result of the decision made at step SD3 is “Yes”, the scenario generation/management section 222 displays at step SD4 a scenario/step list that has become “OK” in the result of the design-supporting scenario. At step SD5, a scenario/steps are selected from this list. At step SD6, the topology of the selected scenario/steps and the parameters of the service rates are taken in from the model material data storage section 400. In the future-forecasting scenario, the topology and the parameters of the service rates are used as constant values.

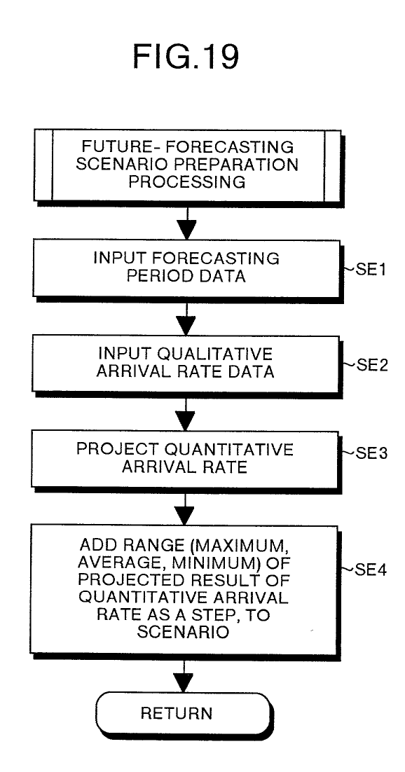

At step SD7, the scenario generation/management section 222 executes a future-forecasting scenario preparation processing for preparing a future-forecasting scenario. In other words, at step SE1 shown in FIG. 19, a forecasting period is input. Specifically, the user selects a forecasting period (three months in this case) from a plurality of forecasting periods (for example, three months, six months, nine months, twelve months, fifteen months, eighteen months, twenty-one months, and twenty-four months) in a forecasting period selection box 753 shown in FIG. 20. The screen 750 shows a scenario input column 751, a noise automatic forecasting mode selection button 752, and a next-screen shift button 754.

At step SE2, the user inputs the qualitative arrival rate data. At step SE3, the scenario generation/management section 222 reads the quantitative arrival rate data (the traffic history data 430 and the transaction history data 450: refer to FIG. 9 and FIG. 10) from the model material data storage section 400. Next, the scenario generation/management section 222 projects the “average arrival interval” and the “average transfer size” (refer to FIG. 9) and the “average arrival interval” and the “average packet size” within the forecasting period (three months in this case), based on the read data and using a simple regressive analysis method.

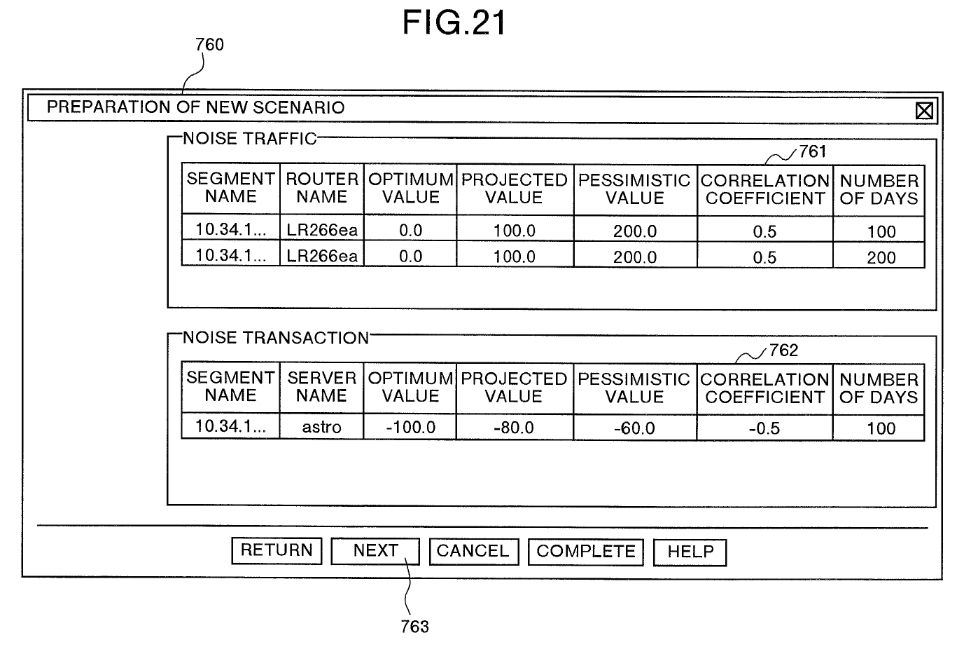

In this projection calculation, projected values of each of the traffic history data 430 and the transaction history data 450 as the qualitative arrival rates are obtained for an upper limit value (a maximum value), an average value, and a lower limit value (a minimum value) respectively within a reliability range of 95%. Thus, the display 610 displays a screen 760 shown in FIG. 21. A noise traffic display column 761 of this screen 760 shows a result of the projection calculation (an upper limit value (a maximum value), an average value, and a lower limit value (a minimum value)) of the traffic history data 430 for each segment.

The “optimistic value” is a lower-limit value (minimum value) in the result of the projection calculation, the “projected value” is an average value in the result of the projection calculation, and the “pessimistic value” is an upper-limit value (maximum value) in the result of the projection calculation. The “correlation coefficient” is a yardstick that expresses a reliability of the result of the projection calculation, and this takes a value in the range from −1 to 1. When the absolute value of a correlation coefficient is closer to 1, the reliability is higher. The “number of days” is a history number of days of the traffic history data 430 used for the projection calculation.

A noise transaction display column 762 shows a result of the projection calculation (an upper limit value (a maximum value), an average value, and a lower limit value (a minimum value)) of the transaction history data 450 for each segment. The “optimistic value” is a lower-limit value (minimum value) in the result of the projection calculation, the “projected value” is an average value in the result of the projection calculation, and the “pessimistic value” is an upper-limit value (maximum value) in the result of the projection calculation. The “correlation coefficient” is a yardstick that expresses a reliability of the result of the projection calculation, and this takes a value in the range from −1 to 1. When the absolute value of a correlation coefficient is closer to 1, the reliability is higher. The “number of days” is a history number of days of the transaction history data 450 used for the projection calculation.

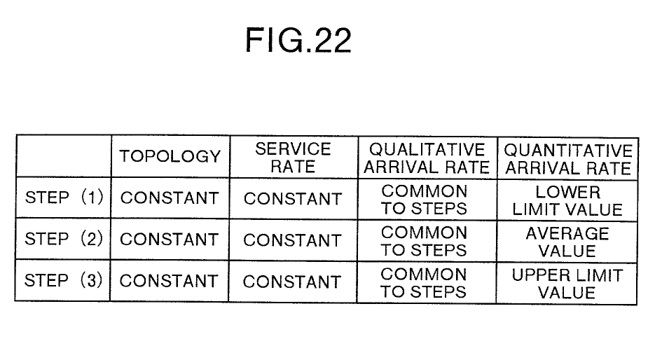

At step SE4, the model generation/management section 221 adds a result of the three projected values (a lower limit value, an average value, and an upper limit value) obtained at step SE3 to the future-forecasting scenario as steps (1) to (3) shown in FIG. 22. In FIG. 22, each of the steps (1) to (3) consists of the data of the “topology” (constant), the “service rate” (constant), the “qualitative arrival rate” (common to each step), and the “quantitative arrival rate” (a lower-limit value, an average value, and an upper-limit value), as the result of the projected values. The future-forecasting scenario in this case corresponds to the scenario 520₁ shown in FIG. 5, and the steps (1) to (3) correspond to the steps 531₁ to 531₃ shown in FIG. 5.

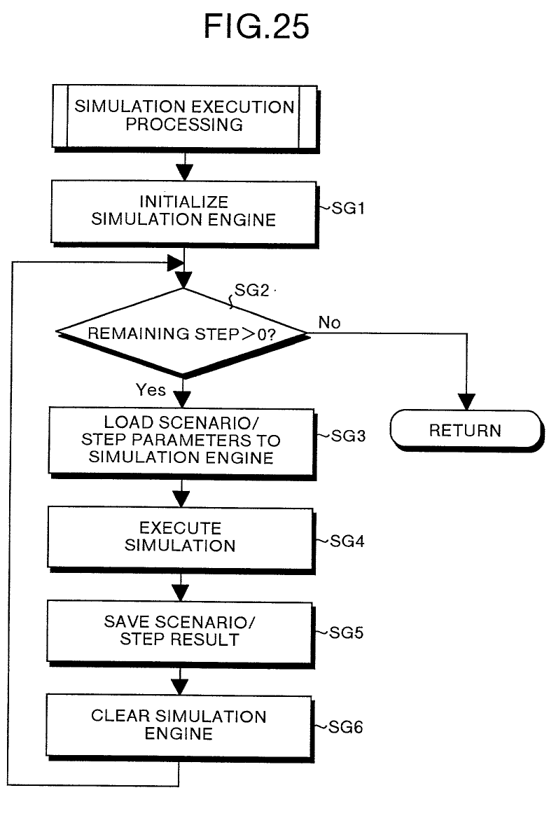

When the future-forecasting scenario preparation processing has been finished, the simulation control section 223 (refer to FIG. 3) executes a simulation based on the future-forecasting scenario, at step SB4 shown in FIG. 11. In other words, at step SG1 shown in FIG. 25, the simulation control section 223 initializes the simulation engine 224. At step SG2, the simulation control section 223 makes a decision as to whether or not there is one or more steps (remaining steps) for executing the simulation. The steps in this case refer to the steps 531₁ to 531₃ shown in FIG. 5. In this case, the simulation control section 223 sets “Yes” as a result of the decision made at step SG2.

At step SG3, the simulation control section 223 reads the parameters (the topology, the service rate, the qualitative arrival rate, and the quantitative arrival rate) corresponding to steps 531₁ to 531₃ (refer to FIG. 22) from the simulation storage section 500, and loads these onto the simulation engine 224. Thus, the simulation engine 224 executes the simulation.

At step SG5, the simulation control section 223 makes the simulation data storage section 500 save a result of the simulation as the step results 532₁ to 532₃ (refer to FIG. 5). At step SG6, the simulation control section 223 clears the simulation engine 224. Thereafter, the processing at step SG2 afterward is repeated. When a result of the decision made at step SG2 is “No”, the simulation control section 223 finishes a series of the processing.

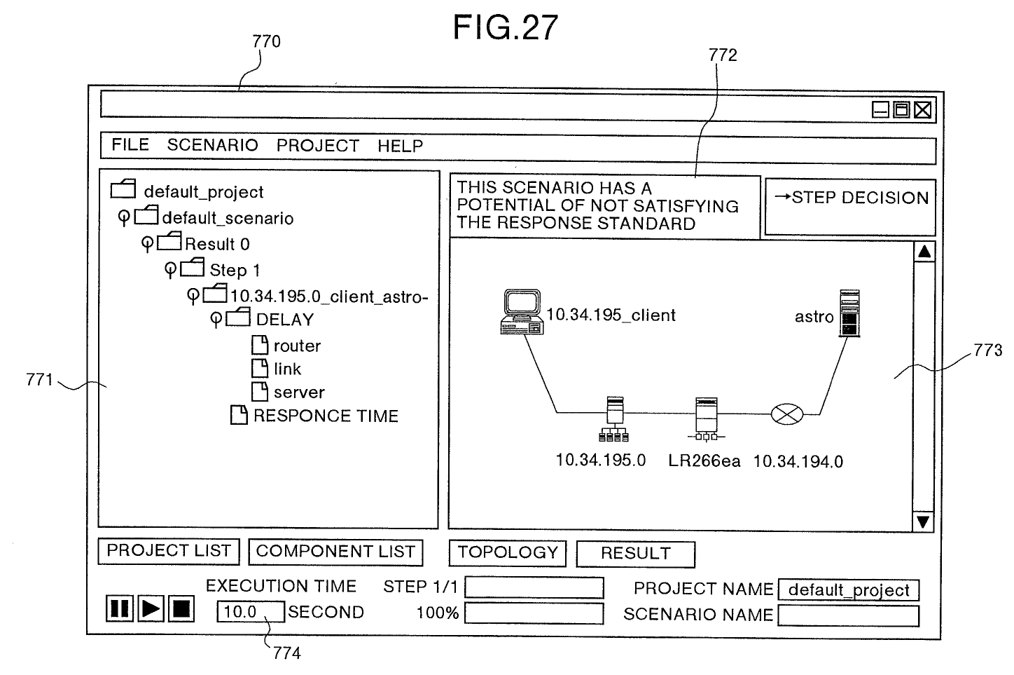

Next, at step SB5 shown in FIG. 11, the result generation/management section 225 starts the result display window 340, thereby to execute the processing for making the display 610 display the simulation result. Based on this processing, the display 610 displays a screen 770 shown in FIG. 27.

In the screen 770, a navigation tree display column 771 displays the navigation tree 350 (refer to FIG. 3), and a result display column 772 displays a result of a decision made as to whether a simulation result based on the scenario (the future-forecasting scenario in this case) satisfies a response standard (the performance standard) or not (in this case, the response standard is not satisfied). A topology display column 773 displays a topology. An execution time display column 774 displays an execution time of the simulation.

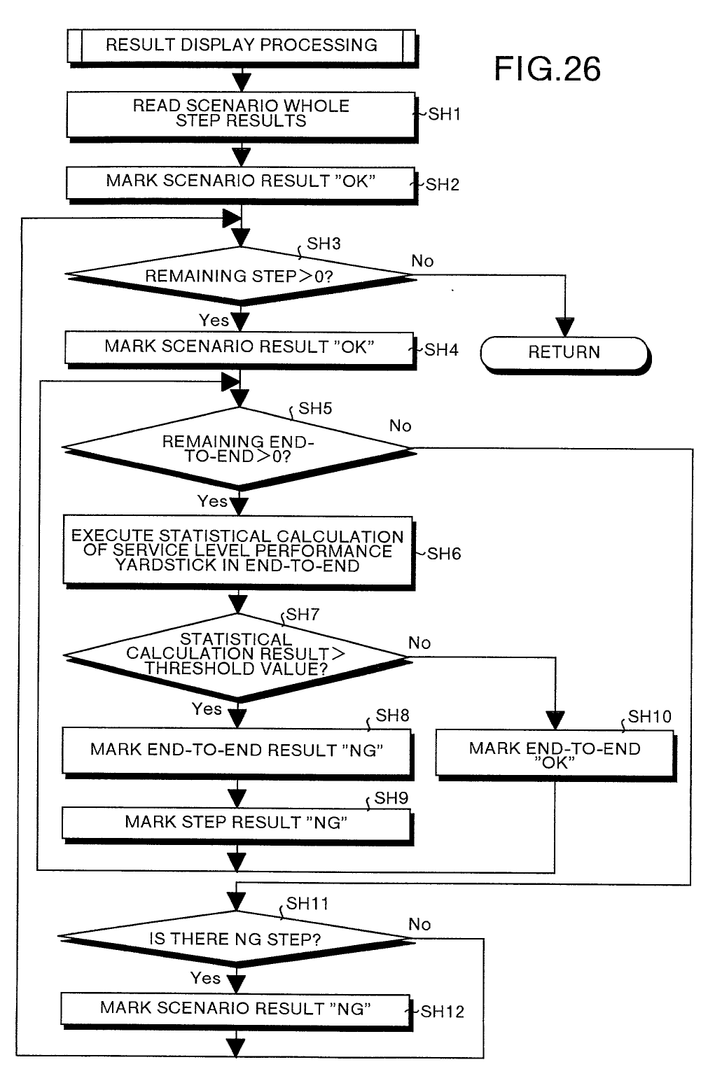

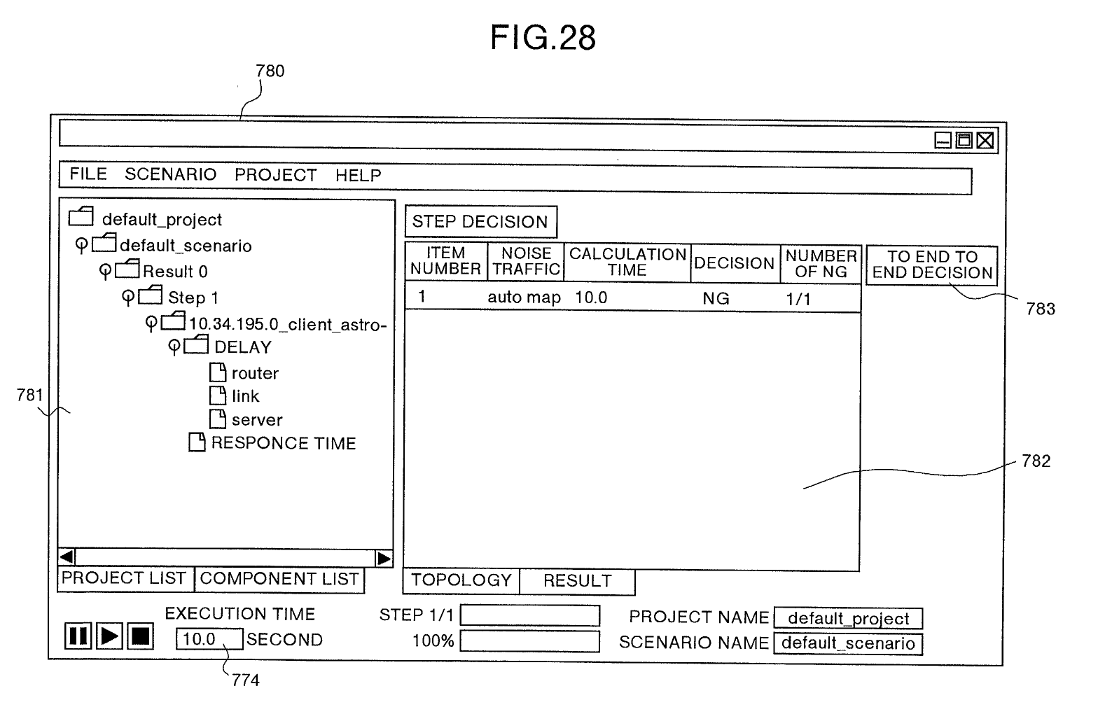

At step SH1 shown in FIG. 26, the result generation/management section 225 reads (returns) the step results 532₁ to 532₃ shown in FIG. 5 from the simulation data storage section 500. At step SH2, the result generation/management section 225 marks “OK” as the scenario result. The “OK” in this case means that the scenario (the future-forecasting scenario in this case) satisfies the response standard. When a “step decision” button shown in FIG. 27 has been depressed, the simulation control section 223 makes the display 610 display a screen 780 shown in FIG. 28.

In the screen 780, a navigation tree display column 781 displays the navigation tree 350 (refer to FIG. 3). A step decision result display column 782 displays a step decision result of a display type corresponding to a step result for each step shown in FIG. 5. The step decision result in this case refers to a result of a decision made as to whether a simulation result at each step satisfies a response standard (the performance standard) or not. When the simulation result satisfies the response standard, “OK” is displayed as a step decision result. On the other hand, when the simulation result does not satisfy the response standard, “NG” is displayed as a step decision result.

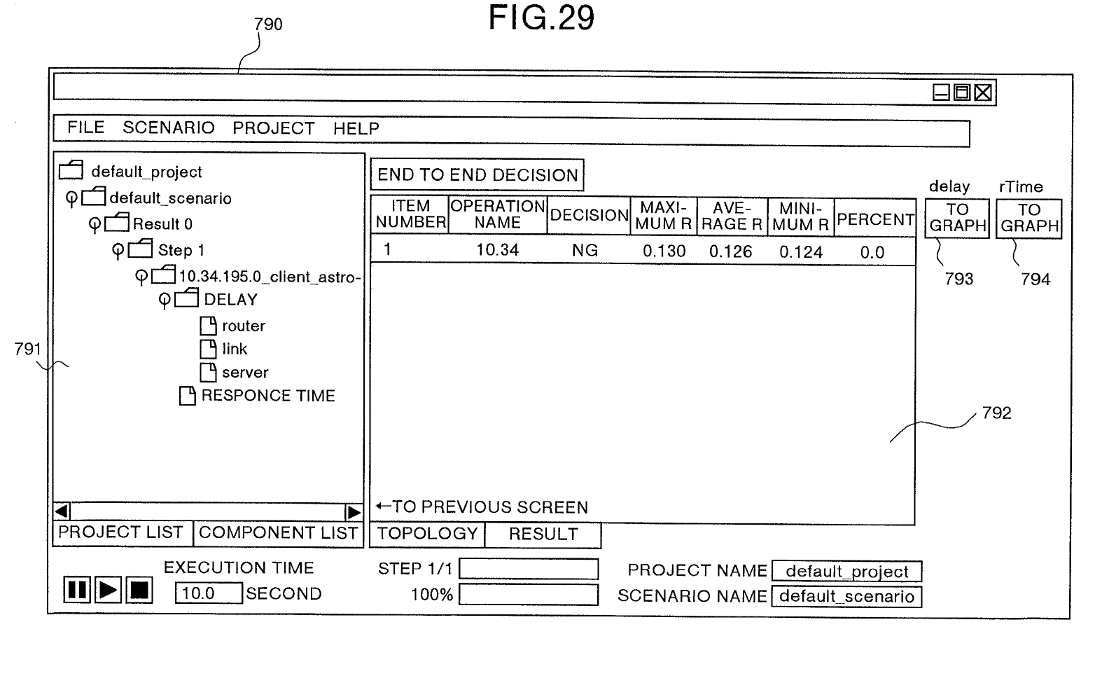

At step SH3, the result generation/management section 225 makes a decision as to whether or not there is one or more steps (remaining steps) at which a step decision is to be made. The steps in this case refer to the steps 531₁ to 531₃ shown in FIG. 5. In this case, the result generation/management section 225 sets “Yes” as a result of the decision made at step SH3. At step SH4, the result generation/management section 225 marks “OK” as a step result (refer to FIG. 5) corresponding to the step. When an “END TO END decision” button 783 shown in FIG. 28 has been depressed, the simulation control section 223 makes the display 610 display a screen 790 shown in FIG. 29.

In the screen 790, a navigation tree display column 791 displays the navigation tree 350 (refer to FIG. 3). An END-TO-END decision result display column 792 displays an End-to-End decision result of a display type corresponding to the End-to-End result shown in FIG. 5. The End-to-End decision result in this case refers to a result of a decision made as to whether or not a simulation result for each End-to-End satisfies a response standard (the performance standard). When the simulation result satisfies the response standard, “OK” is displayed as an End-to-End decision result. On the other hand, when the simulation result does not satisfy the response standard, “NG” is displayed as an End-to-End decision result.

At step SH5, the result generation/management section 225 makes a decision as to whether or not there is one or more End-to-End results for which End-to-End decision is to be made corresponding to steps shown in FIG. 5. The End-to-End decision in this case refers to a decision as to whether or not the End-to-End result satisfies a threshold value (the performance standard). In this case, the result generation/management section 225 sets “Yes” as a result of the decision made at step SH5. At step SH6, the result generation/management section 225 executes a statistical calculation of a service level performance standard in the End-to-End shown in FIG. 5.

At step SH7, the result generation/management section 225 makes a decision as to whether a statistical calculation result is larger than a threshold value or not. When a result of the decision made at step SH7 is “No”, at step SH10, the result generation/management section 225 marks “OK” as an End-to-End result in the “decision” column of the END-TO-END decision result display column 792 shown in FIG. 29. On the other hand, when a result of the decision made at step SH7 is “Yes”, the result generation/management section 225 marks “NG” as an End-to-End result in the “decision” column of the END-TO-END decision result display column 792. At step SH9, the result generation/management section 225 marks “NG” in the “decision” column of the step decision result display column 782 shown in FIG. 28.

Thereafter, the processing at step SH5 afterward is repeated. When a result of the decision made at step SH5 is “No”, at step SH11, the result generation/management section 225 makes a decision as to whether or not there is a step of “NO” in the step result. When a result of the decision made at step SH11 is “Yes” , the result generation/management section 225 sets “NG” as a scenario result. In this case, the result display column 772 shown in FIG. 27 displays characters “This scenario has a possibility of not satisfying the response standard”.

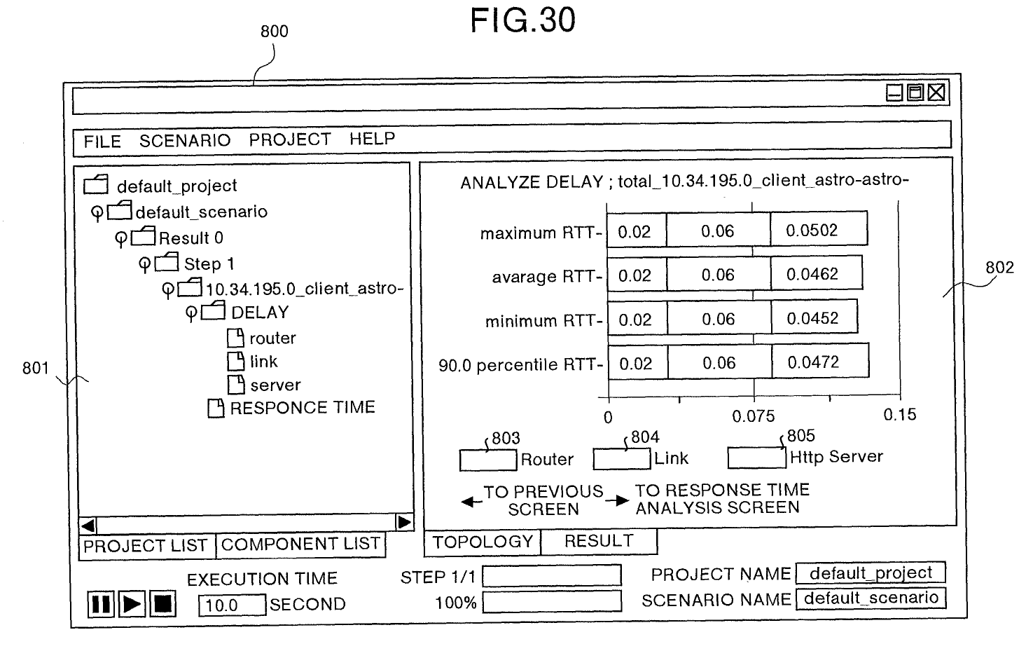

When a graph display screen shift button 793 shown in FIG. 29 has been depressed, the result generation/management section 225 makes the display 610 display a screen 800 shown in FIG. 30. In the screen 800, a navigation tree display column 801 displays the navigation tree 350 (refer to FIG. 3). A graph display column 802 displays a graph of a delay time corresponding to a simulation result. This graph consists of a router portion 803, a link portion 804, and an HTTP server portion 805.

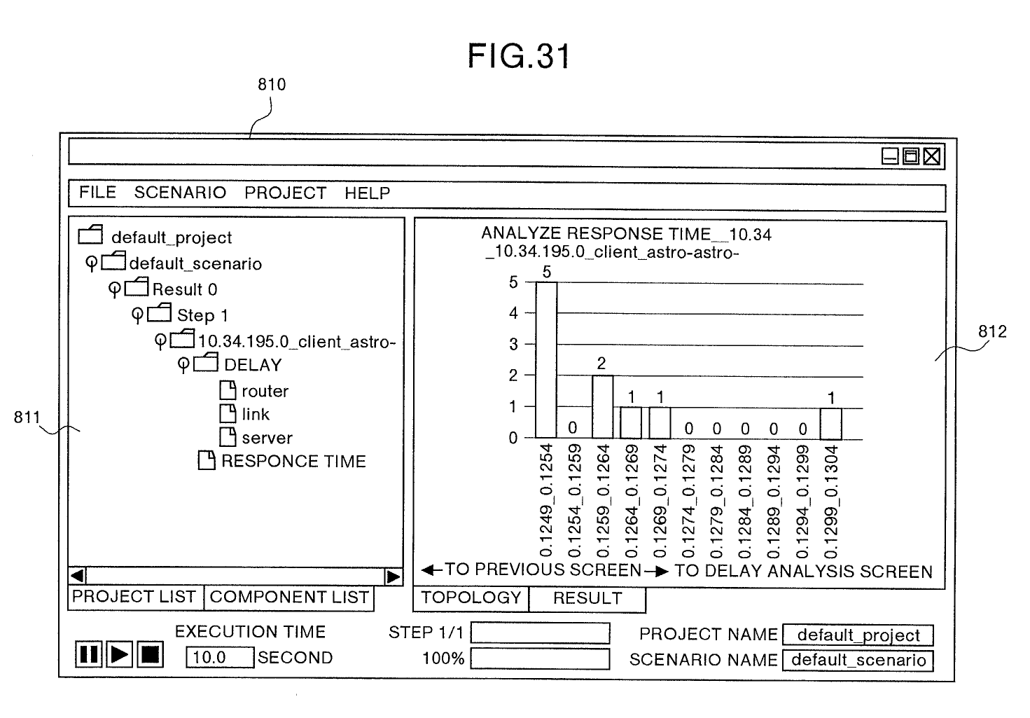

When a graph display screen shift button 794 shown in FIG. 29 has been depressed, the result generation/management section 225 makes the display 610 display a screen 810 shown in FIG. 31. In the screen 810, a navigation tree display column 811 displays the navigation tree 350 (refer to FIG. 3). A graph display column 812 displays a graph of a round trip time corresponding to a simulation result.

Thereafter, the processing at step SH3 afterward is repeated. When a result of the decision made at step SH3 is “No”, at step SB6 shown in FIG. 11, the result generation/management section 225 makes a decision as to whether or not the scenario result in the result display processing at step SB5 is “OK” or not. In other words, a decision is made as to whether the simulation result corresponding to the scenario (the future-forecasting scenario in this case) satisfies a service level (the performance standard) or not. When a result of the decision made at step SB6 is “Yes”, all the processing is finished. When a result of the decision made at step SB6 is “No”, the processing at step SB3 afterward is repeated.

On the other hand, when a result of the decision made at step SD1 shown in FIG. 18 is “No”, at step SD9, the user selects one of the future-forecasting scenario and the design-supporting scenario. At step SD10, the scenario generation/management section 222 makes a decision as to whether the selected scenario is the design-supporting scenario or no. When a result of the decision made at step SD10 is “No”, the processing at step SD2 afterward is repeated.

In this case, it is assumed that the design-supporting scenario has been selected. Then, the scenario generation/management section 222 sets “Yes” as a result of the decision made at step SD10. At step SD11, the scenario generation/management section 222 starts the design-supporting wizard 322. Thus, the display 610 displays a screen (not shown) for generating the design-supporting scenario.

At step SD12, the scenario generation/management section 222 makes the display 610 display a list of the results that show “NO” (the scenario result 530 (refer to FIG. 3)) based on the future-forecasting scenario. At step SD13, the user selects a scenario/steps from the list. At step SD14, the scenario generation/management section 222 takes in the parameters of the quantitative arrival rate and the qualitative arrival rate of the selected scenario/steps, from the model material data storage section 400. In the design-supporting scenario, the parameters of the quantitative arrival rate and the qualitative arrival rate are used as constant values.

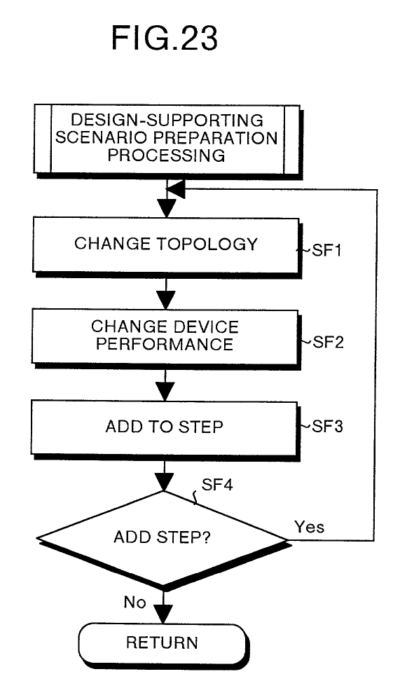

At step SD15, the scenario generation/management section 222 executes the design-supporting scenario preparation processing for preparing the design-supporting scenario. In other words, at step SF1 shown in FIG. 23, the scenario generation/management section 222 changes the topology among the parameters based on an assignment of the user. When there is no assignment from the user, the topology is not changed. At step SF2, the scenario generation/management section 222 changes the device performance (the service rate) based on an assignment of the user. When there is no assignment from the user, the service rate is not changed.

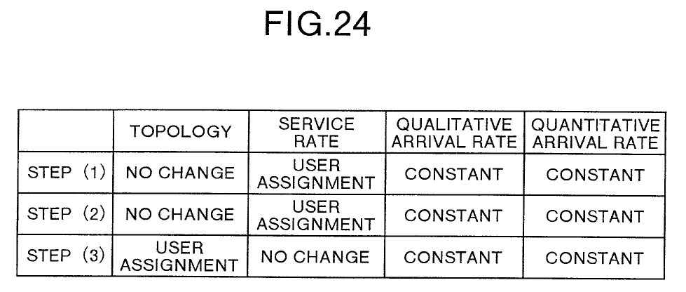

At step SF3, the scenario generation/management section 222 adds the topology and the service rate to the steps (1) to (3) shown in FIG. 24. In FIG. 24, each of the steps (1) to (3) consists of the data of the “topology” (a variable value of a user assignment or no change), the “service rate” (a variable value of a user assignment or no change), the “qualitative arrival rate” (constant), and the “quantitative arrival data” (constant) respectively.

The design-supporting scenario in this case corresponds to the scenario 520₂ shown in FIG. 5, and the steps (1) to (3) correspond to the steps (not shown) of the scenario 520₂ shown in FIG. 5. At step SF4, a decision is made as to whether a step is further added or not. When a result of the decision made at step SF4 is “Yes”, the processing at step SF1 afterward is repeated.

In this case, it is assumed that a result of the decision made at step SF4 is “No”. At step SB4 shown in FIG. 11, the simulation control section 223 (refer to FIG. 3) executes a simulation based on the design-supporting scenario in a similar manner to that of the future-forecasting scenario.

At step SB5, the result generation/management section 225 displays the simulation result corresponding to the design-supporting scenario in a similar manner to that of the future-forecasting scenario. At step SB6, the result generation/management section 225 makes a decision as to whether or not the scenario result in the result display processing at step SB5 is “OK” or not. In other words, a decision is made as to whether the simulation result corresponding to the scenario (the design-supporting scenario in this case) satisfies a service level (the performance standard) or not. When a result of the decision made at step SB6 is “Yes”, all the processing is finished.

As explained above, according to the present embodiment, the model generation/management section 221 prepares the future-forecasting scenario and the design-supporting scenario. A simulation is executed corresponding to the design-supporting scenario or the future-forecasting scenario, based on a result of a simulation of the future-forecasting scenario or the design-supporting scenario. Therefore, even a general user can effectively carry out a simulation without the need for high-level knowledge about simulation or without a burden applied to the user side.

Further, according to the present embodiment, the simulation control section 223 controls the sequence of executing a simulation by utilizing a mutual relationship between the future-forecasting scenario and the design-supporting scenario. Therefore, it is possible to execute a simulation by organically combining the two scenarios. This can reduce the burden on the user side.

Further, according to the present embodiment, even a general user can effectively carry out a simulation without the need for high-level knowledge about simulation or without a burden applied to the user side regarding the computer network 100.

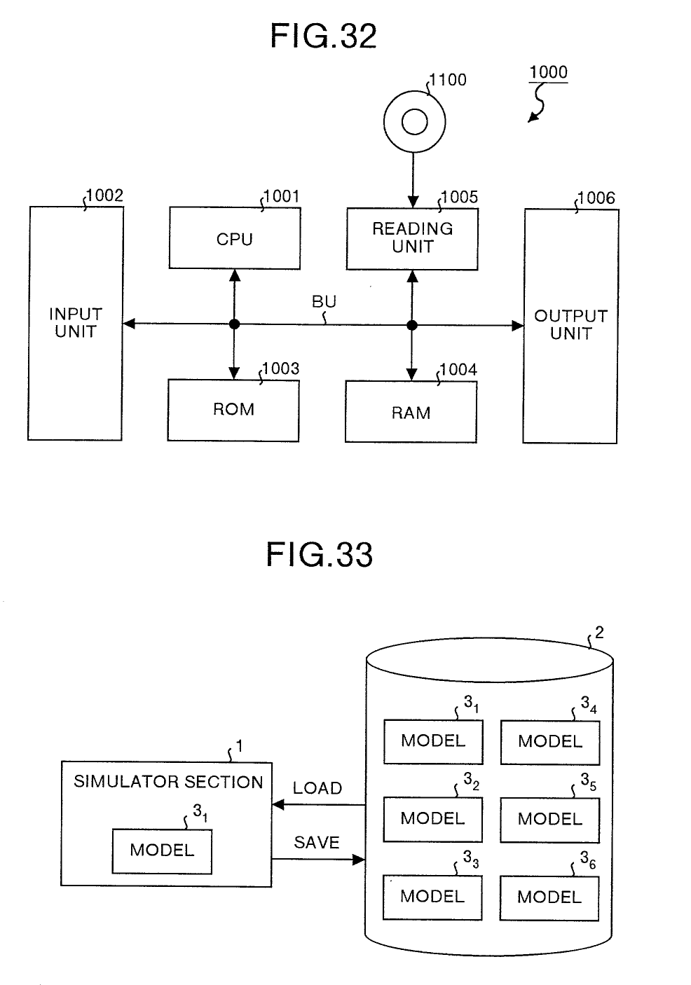

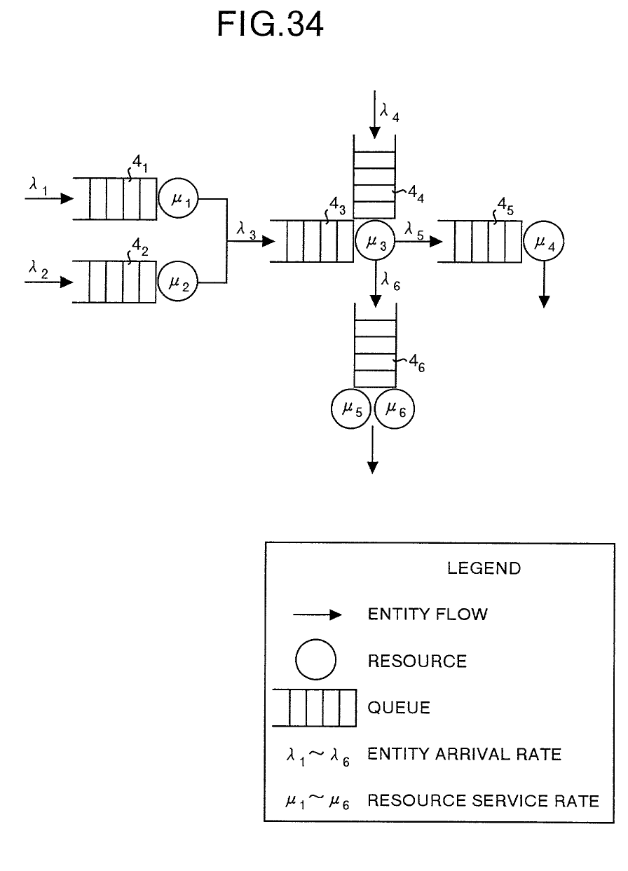

While the embodiment relating to the present invention has been explained in detail with reference to the drawings, the embodiment is not limited to the one described above. Any design change within the scope not deviating from the gist of the present invention is included in the present invention. For example, in the above-described embodiment, it may be so arranged that a computer-readable recording medium 1100 shown in FIG. 32 is recorded with a simulation program for realizing the functions of the simulator, and a computer 1000 shown in FIG. 32 reads and executes the simulation program recorded in the recording medium 1100, thereby to execute a simulation.

The computer 1000 shown in FIG. 32 consists of a CPU 1001 that executes the simulation program, an input unit 1002 such as a keyboard and a mouse, a ROM (Read-only Memory) 1003 that stores various data, a RAM (Random Access Memory) 1004 that stores arithmetic parameters, a reading unit 1005 that reads the simulation program from the recording medium 1100, an output unit such as a display and a printer, and a bus BU that connects between the units of the device.

The CPU 1001 reads the simulation program recorded in the recording medium 1100, via the reading unit 1005. The CPU 1001 then executes the simulation program, thereby to carry out the simulation. The recording medium 1100 includes not only a portable recording medium such as an optical disk, a floppy disk, a hard disk, etc. but also includes a transfer medium that temporarily stores and holds data like a network.

As explained above, according to the present invention, a future-forecasting scenario and a design-supporting scenario are prepared, and a simulation is executed corresponding to the design-supporting scenario or the future-forecasting scenario, based on a result of a simulation of the future-forecasting scenario or the design-supporting scenario. Therefore, there is an effect that even a general user can effectively carry out a simulation without the need for high-level knowledge about simulation or without a burden applied to the user side.

Further, the sequence of executing a simulation is controlled by utilizing a mutual relationship between the future-forecasting scenario and the design-supporting scenario. Therefore, there is an effect that it is possible to execute a simulation by organically combining the two scenarios. This has an effect of reducing the burden on the user side.

Further, there is an effect that even a general user can effectively carry out a simulation without the need for high-level knowledge about simulation or without a burden applied to the user side regarding a network and a simulation system consisting of network devices.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A simulator comprising:
a model preparation unit that prepares a model corresponding to a system to be simulated;
a future-forecasting scenario preparation unit that prepares a future-forecasting scenario for verifying a state that said system does not satisfy a predetermined performance standard in future, based on a result of executing a simulation of the model;
a design-supporting scenario preparation unit that prepares a design-supporting scenario for verifying a state that said system satisfies a performance standard, based on a result of executing a simulation of the model;
a simulation execution unit that executes a simulation corresponding to the future-forecasting scenario or the design-supporting scenario; and
a simulation control unit that makes said simulation execution unit execute a simulation corresponding to the design-supporting scenario or the future-forecasting scenario, based on a result of the simulation of the future-forecasting scenario or the design-supporting scenario.

2. The simulator according to claim 1, wherein said simulation control unit controls the sequence of executing a simulation by utilizing a mutually dependent relationship between the future-forecasting scenario and the design-supporting scenario.

3. The simulator according to claim 1, wherein said system includes a network to which many network devices are connected.

4. The simulator according to claim 3, wherein said future-forecasting scenario preparation unit prepares the future-forecasting scenario by setting a topology and a service rate as constants and setting a qualitative arrival rate and a quantitative arrival rate as variables among parameters of said network and said network devices.

5. The simulator according to claim 3, wherein said design-supporting scenario preparation unit prepares the design-supporting scenario by setting a qualitative arrival rate and a quantitative arrival rate as constants and setting a topology and a service rate as variables among parameters of said network and said network devices.

6. The simulator according to claim 2, wherein said system includes a network to which many network devices are connected.

7. The simulator according to claim 6, wherein said future-forecasting scenario preparation unit prepares the future-forecasting scenario by setting a topology and a service rate as constants and setting a qualitative arrival rate and a quantitative arrival rate as variables among parameters of said network and said network devices.

8. The simulator according to claim 6, wherein said design-supporting scenario preparation unit prepares the design-supporting scenario by setting a qualitative arrival rate and a quantitative arrival rate as constants and setting a topology and a service rate as variables among parameters of said network and said network devices.

9. A simulation method comprising the steps of:
preparing a model corresponding to a system to be simulated;
preparing a future-forecasting scenario for verifying a state that said system does not satisfy a predetermined performance standard in future, based on a result of executing a simulation of the model;
preparing a design-supporting scenario for verifying a state that said system satisfies a performance standard, based on a result of executing a simulation of the model;
executing a simulation corresponding to the future-forecasting scenario or the design-supporting scenario; and
making a simulation corresponding to the design-supporting scenario or the future-forecasting scenario to be executed at the simulation execution step, based on a result of the simulation of the future-forecasting scenario or the design-supporting scenario.

10. The simulation method according to claim 9, wherein at the simulation control step, the sequence of executing a simulation is controlled by utilizing a mutually dependent relationship between the future-forecasting scenario and the design-supporting scenario.

11. The simulation method according to claim 9, wherein said system includes a network to which many network devices are connected.

12. The simulation method according to claim 10, wherein said system includes a network to which many network devices are connected.

13. A computer-readable recording medium which records a computer program that includes instruction which when executed on a computer causes the computer to perform the steps of:
preparing a model corresponding to a system to be simulated;
preparing a future-forecasting scenario for verifying a state that said system does not satisfy a predetermined performance standard in future, based on a result of executing a simulation of the model;
preparing a design-supporting scenario for verifying a state that said system satisfies a performance standard, based on a result of executing a simulation of the model;
executing a simulation corresponding to the future-forecasting scenario or the design-supporting scenario; and
making a simulation corresponding to the design-supporting scenario or the future-forecasting scenario to be executed at the simulation execution step, based on a result of the simulation of the future-forecasting scenario or the design-supporting scenario.

14. A computer-readable recording medium which records a computer program that includes instruction which when executed on a computer causes the computer to perform the steps of:
preparing a model corresponding to a system to be simulated;
preparing a future-forecasting scenario for verifying a state that said system does not satisfy a predetermined performance standard in future, based on a result of executing a simulation of the model;
preparing a design-supporting scenario for verifying a state that said system satisfies a performance standard, based on a result of executing a simulation of the model;
executing a simulation corresponding to the future-forecasting scenario or the design-supporting scenario; and
making a simulation corresponding to the design-supporting scenario or the future-forecasting scenario to be executed at the simulation execution step, based on a result of the simulation of the future-forecasting scenario or the design-supporting scenario,
wherein at the simulation control step, the sequence of executing a simulation is controlled by utilizing a mutually dependent relationship between the future-forecasting scenario and the design-supporting scenario.

15. A computer-readable recording medium which records a computer program that includes instruction which when executed on a computer causes the computer to perform the steps of:
preparing a model corresponding to a system to be simulated;
preparing a future-forecasting scenario for verifying a state that said system does not satisfy a predetermined performance standard in future, based on a result of executing a simulation of the model;
preparing a design-supporting scenario for verifying a state that said system satisfies a performance standard, based on a result of executing a simulation of the model;
executing a simulation corresponding to the future-forecasting scenario or the design-supporting scenario; and
making a simulation corresponding to the design-supporting scenario or the future-forecasting scenario to be executed at the simulation execution step, based on a result of the simulation of the future-forecasting scenario or the design-supporting scenario,
wherein said system includes a network to which many network devices are connected.

16. A computer-readable recording medium which records a computer program that includes instruction which when executed on a computer causes the computer to perform the steps of:
preparing a model corresponding to a system to be simulated;
preparing a future-forecasting scenario for verifying a state that said system does not satisfy a predetermined performance standard in future, based on a result of executing a simulation of the model;
preparing a design-supporting scenario for verifying a state that said system satisfies a performance standard, based on a result of executing a simulation of the model;
executing a simulation corresponding to the future-forecasting scenario or the design-supporting scenario; and
making a simulation corresponding to the design-supporting scenario or the future-forecasting scenario to be executed at the simulation execution step, based on a result of the simulation of the future-forecasting scenario or the design-supporting scenario,
wherein at the simulation control step, the sequence of executing a simulation is controlled by utilizing a mutually dependent relationship between the future-forecasting scenario and the design-supporting scenario,
wherein said system includes a network to which many network devices are connected.
